(19) United States
(12) Patent Application Publication
(10) Pub. No.: US 2012/0294643 A1
(43) Pub. Date: Nov. 22, 2012

(54) IMAGE FORMING APPARATUS

(75) Inventors: Tomohisa Itagaki, Abiko-shi (JP); Nobuhiko Zaima, Kashiwa-shi (JP); Yasuhito Shirafuji, Kashiwa-shi (JP); Takahiro Ishihara, Maebashi-shi (JP)

(73) Assignee: CANON KABUSHIKI KAISHA, Tokyo (JP)

(21) Appl. No.: 13/399,924

(22) Filed: Feb. 17, 2012

(30) Foreign Application Priority Data
Mar. 3, 2011 (JP) 2011-046515

(51) Int. Cl. G03G 15/00

(52) U.S. Cl. 399/72

(57) ABSTRACT

An image forming apparatus includes a conveyance unit to convey an image carrier and an image forming unit to form an image on the image carrier. The image forming apparatus also includes a first determining unit, a control unit, an irradiation unit, an output unit, and a second determining unit. The first determining unit determines a first image forming condition of the image forming unit for forming a heavy line image at a particular width and thickness. The control unit causes the image forming unit to form a first measurement image having a particular width and length. The irradiation unit emits light onto the image carrier. The output unit outputs a first signal corresponding to a thickness of the first measurement image by receiving reflected light. The second determining unit determines a second image forming condition for forming a fine line image at a particular width and thickness.

### BACKGROUND OF THE INVENTION

1. Field of the Invention

The present invention relates to a method for controlling an image forming apparatus employing an electrophotographic method by measuring an amount of toner of a toner image and correcting a density of an image to be formed.

2. Description of the Related Art

Regarding a full-color image forming apparatus employing an electrophotographic method, electrostatic latent images are formed corresponding to each of a plurality of color components and developed by developer including toner of each color component. When the electrostatic latent images are developed, toner images of each color component are formed. By superimposing and transferring these toner images of each color component on a transfer unit, a full-color toner image corresponding to the original image is formed. Then, by a fixing unit applying heat and pressure to the toner image, the toner image is fixed to the sheet. Then, the sheet is output from the image forming apparatus as a printed output.

The density of the toner image formed by the image forming apparatus is determined by the amount of toner used per unit area of the formed toner image.

When the toner images of a plurality of color components are superimposed in forming a full-color toner image, if the amount of toner (amount of toner per unit area) of the toner images that are superimposed exceeds an upper limit of the toner amount, repulsion of the toner particles of the same polarity occurs. This causes toner scattering. Further, when fixing a toner image onto a sheet, if an excessive amount of toner is applied to the superimposed images, not all of the toner particles can be fixed. Accordingly, toner scattering occurs due to heat and pressure applied by a fixing device.

It is known that the toner scattering tends to occur at a fine line portion of a line image or a character. If the toner scattering occurs at a fine line portion of a line image, a thicker line is formed compared to the original line. Further, if the toner scattering occurs at a character portion, it makes the character illegible.

Under such circumstances, Japanese Patent Application Laid-Open No. 2007-199591 discusses a method for detecting a thickness of a toner image of a fine line formed on an image carrier and controlling the thickness of the toner image so that it is kept to a thickness that does not produce the toner scattering. The thickness in the direction perpendicular to the surface of the image carrier is considered as the thickness of the toner image and the thickness is controlled by setting image forming conditions such as charge potential, development condition, exposure condition, and transfer condition of the photosensitive member. To be more precise, the thickness is detected by a light-receiving element that receives a laser beam. In other words, a laser beam with a spot diameter smaller than a width of a fine line toner image is emitted to a fine line toner image formed on an image carrier. Then, from a light-receiving position of the light-receiving element that receives the light reflected by the fine line toner image, the thickness that corresponds to the amount of toner adhering to the fine line toner image can be detected.

Regarding the fine line toner image, the thickness of the toner image is increased when the amount of adhering toner is increased. Further, if the amount of adhering toner is reduced, the thickness of the toner image is also reduced. Since the light-receiving position of the light-receiving element which receives the light reflected by the fine line toner image is changed corresponding to the thickness of the fine line toner image, the thickness of the fine line toner image can be obtained by detecting the light-receiving position.

However, the method discussed in Japanese Patent Application Laid-Open No. 2007-199591 determines the image forming condition of a character or a fine line portion based on the thickness of the fine line toner image regardless of the direction of the line.

### SUMMARY OF THE INVENTION

The present invention is directed to an image forming apparatus that can prevent toner scattering of a character or a fine line portion even if a line whose longitudinal direction is the same as the conveying direction of the image carrier is included in the image.

According to experiments of the inventors of the present invention, however, the thickness of a fine line toner image whose longitudinal direction is the same as the conveying direction of the image carrier tends to be thicker than the thickness of a fine line toner image whose longitudinal direction is perpendicular to the conveying direction of the image carrier.

Thus, toner scattering may occur even if a thickness of a character or a fine line portion of a toner image is controlled by an image forming condition determined by the method discussed in Japanese Patent Application Laid-Open No. 2007-199591.

According to an aspect of the present invention, an image forming apparatus includes an image carrier configured to carry an image, a conveyance unit configured to convey the image carrier, an image forming unit configured to form an image on the image carrier according to image data, a first determining unit configured to determine a first image forming condition of the image forming unit for forming a heavy line image at a width that is wider than a predetermined width such that a thickness of the heavy line image, in a direction orthogonal to a surface of the image carrier, is thinner than or equal to a predetermined thickness, a control unit configured to cause the image forming unit to form a first measurement image having a width that is narrower than or equal to the predetermined width such that a length of the first measurement image, in a direction perpendicular to a conveying direction of the image carrier by the conveyance unit, is shorter than a predetermined length, an irradiation unit configured to emit light onto the image carrier, an output unit configured to output a first signal corresponding to a thickness of the first measurement image in a direction orthogonal to the surface of the image carrier by receiving light reflected by the first measurement image, and a second determining unit configured to determine a second image forming condition of the image forming unit for forming a fine line image at a width that is narrower than or equal to the predetermined width, based on the first signal output by the output unit, such that the thickness of the fine line image is thinner than or equal to the predetermined thickness.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic cross section drawing of an image forming apparatus.

FIGS. 2A and 2B are schematic diagrams of a main portion of a thickness detection unit.

FIGS. 3A and 3B illustrate a relation between light intensity and a light-receiving position measured by the thickness detection unit.

FIG. 4 illustrates a relation between a light-receiving position difference and a toner image thickness.

FIG. 5 is a control block diagram of the image forming apparatus according to a first exemplary embodiment.

FIG. 6 illustrates a relation between a width and a thickness of a toner image.

FIGS. 7A and 7B are schematic diagrams illustrating a solid patch image and a fine line patch image carried on an intermediate transfer belt according to the first exemplary embodiment.

FIG. 8 is a flowchart illustrating image forming processing of the image forming apparatus according to the first exemplary embodiment.

FIG. 9 is a flowchart illustrating processing for determining a first image forming condition according to the first exemplary embodiment.

FIG. 10 is a flowchart illustrating processing for identifying an upper limit of a signal level according to the first exemplary embodiment.

FIG. 11 is a flowchart illustrating identifying processing of a thickness ratio of a black toner image according to the first exemplary embodiment.

FIG. 12 illustrates an example of image data written in a page description language.

FIG. 13 is a schematic diagram of the image data after conversion.

FIG. 14 is a flowchart illustrating signal level correction processing according to the first exemplary embodiment.

FIGS. 15A and 15B are schematic diagrams of a solid patch image and a fine line patch image carried on the intermediate transfer belt according to a second exemplary embodiment.

### DESCRIPTION OF THE EMBODIMENTS

Various exemplary embodiments, features, and aspects of the invention will be described in detail below with reference to the drawings.

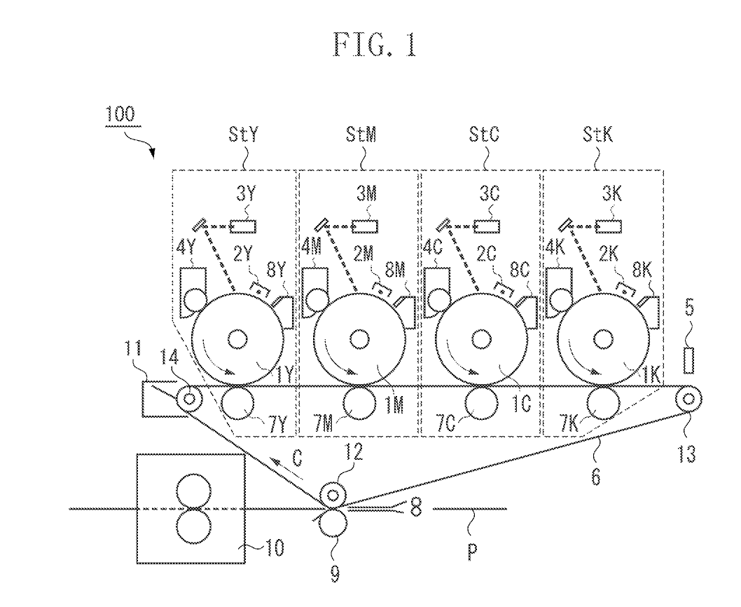

A first exemplary embodiment will be described. FIG. 1 is a schematic cross section drawing of an image forming apparatus 100 according to the present embodiment. The image forming apparatus 100 according to the present embodiment includes four image forming units StY, StM, StC, and StK arranged in a row. Each of these image forming units forms a toner image of each color component.

The image forming unit StY forms a yellow toner image, the image forming unit StM forms a magenta toner image, the image forming unit StC forms a cyan toner image, and the image forming unit StK forms a black toner image.

The image forming unit StY includes a photosensitive drum 1Y, a charging device 2Y, and an exposure unit 3Y. The photosensitive drum 1Y carries a toner image of a yellow color component. The charging device 2Y charges the photosensitive drum 1Y. The exposure unit 3Y exposes the charged surface of the photosensitive drum 1Y to light to form an electrostatic latent image corresponding to the yellow color component on the photosensitive drum 1Y. Further, the image forming unit StY includes a developing unit 4Y and a primary transfer roller 7Y. The developing unit 4Y visualizes the electrostatic latent image formed on the photosensitive drum 1Y as a toner image by using developer including toner. The primary transfer roller 7Y transfers the toner image formed on the photosensitive drum 1Y to an intermediate transfer belt 6 described below. Further, the image forming unit StY includes a drum cleaner 8Y that removes residual toner on the photosensitive drum 1Y after the transfer of the toner image.

Since components of other image forming units StM, StC, and StK are similar to those of the image forming unit StY that forms a yellow toner image described above, the components corresponding to the image forming unit StY are denoted by the same numeral with different alphabetic letters and their descriptions are not repeated.

The intermediate transfer belt 6 is an image carrier that carries a toner image. Since the intermediate transfer belt 6 carries superimposed toner images of each color component formed by the image forming units StY, StM, StC, and StK, a full-color toner image is formed.

Further, a secondary transfer roller 9 and a roller 12 are provided in the periphery of the intermediate transfer belt 6. These rollers are used for transferring the toner image formed on the intermediate transfer belt 6 to a sheet P, which is, for example, paper. Furthermore, a thickness detection unit 5 and a belt cleaner 11 are provided in the periphery of the intermediate belt 6. The thickness detection unit 5, which is described in detail below, detects a thickness of the toner image carried by the intermediate transfer belt 6. The belt cleaner 11 removes residual toner that remains on the intermediate transfer belt 6 after the toner image is transferred to the sheet P.

Next, the image forming operation of the image forming apparatus 100 regarding output of an image corresponding to image data which has been generated by a reading unit (not illustrated) for reading a document or image data input from a personal computer (PC) or the like will be described.

First, the charging devices 2Y, 2M, 2C, and 2K of the image forming units StY, StM, StC, and StK uniformly charge the photosensitive drums 1Y, 1M, 1C, and 1K. Next, each of the exposure units 3Y, 3M, 3C, and 3K exposes each of the corresponding photosensitive drums 1Y, 1M, 1C, and 1K with light corresponding to a density value of each color component of image data. Accordingly, an electrostatic latent image of the image data is formed for each color component. Then, each of the electrostatic latent images formed on the photosensitive drums 1Y, 1M, 1C, and 1K is visualized as a toner image of each color component by the developing units 4Y, 4M, 4C, and 4K.

The toner image of each color component formed on each of the photosensitive drums 1Y, 1M, 1C, and 1K is conveyed to a corresponding primary transfer nip portion. The primary transfer nip portion is where each of the primary transfer rollers 7Y, 7M, 7C, and 7K presses the photosensitive drums 1Y, 1M, 1C, and 1K via the intermediate transfer belt 6 according to the rotation of each of the corresponding photosensitive drums 1Y, 1M, 1C, and 1K. At this primary transfer nip portion, a primary transfer voltage is applied to the toner image of each color component on each of the photosensitive drums 1Y, 1M, 1C, and 1K by each of the primary transfer rollers 7Y, 7M, 7C, and 7K and the toner images are sequentially superimposed and transferred to the intermediate transfer belt 6. In this manner, a full-color toner image is formed on the intermediate transfer belt 6. Further, residual toner on the photosensitive drums 1Y, 1M, 1C, and 1K is removed by the drum cleaners 8Y, 8M, 8C, and 8K.

The toner image transferred to the intermediate transfer belt 6 is conveyed to a secondary transfer nip portion. The secondary transfer nip portion is where the secondary transfer roller 9 presses the roller 12 via the intermediate transfer belt 6. On the other hand, the sheet P is also conveyed to the secondary transfer nip portion at the right time for the contact of the full-color toner image. Then, by the secondary transfer roller 9, to which secondary transfer voltage is applied, a full-color toner image formed on the intermediate transfer belt 6 is transferred to the sheet P. The sheet P that carries the toner image is conveyed to a fixing device 10. Then, the toner image is fixed by heat and pressure of the fixing device 10. Further, the residual toner on the intermediate transfer belt 6 untransferred to the sheet P at the secondary transfer nip portion is removed by the belt cleaner 11.

Further, the image forming apparatus 100 forms electrostatic latent images corresponding to toner images used for measuring density by exposing the photosensitive drums 1Y, 1M, 1C, and 1K to light by the exposure units 3Y, 3M, 3C, and 3K. Such toner images are referred to as patch images. When the electrostatic latent images are visualized by the developing units 4Y, 4M, 4C, and 4K, the visualized patch images are transferred to the intermediate transfer belt 6 by the primary transfer rollers 7Y, 7M, 7C, and 7K. The thickness of the patch images formed on the intermediate transfer belt 6 is detected by the above-described thickness detection unit 5. The thickness of each of the patch images corresponds to its density.

In other words, the density of a patch image is determined by the amount of toner adhering to the patch image. When the adhering amount of toner of the patch image increases, it means that the thickness of the patch image is increased. The thickness of this patch image is the thickness of the patch image in the direction perpendicular to the surface of the intermediate transfer belt 6.

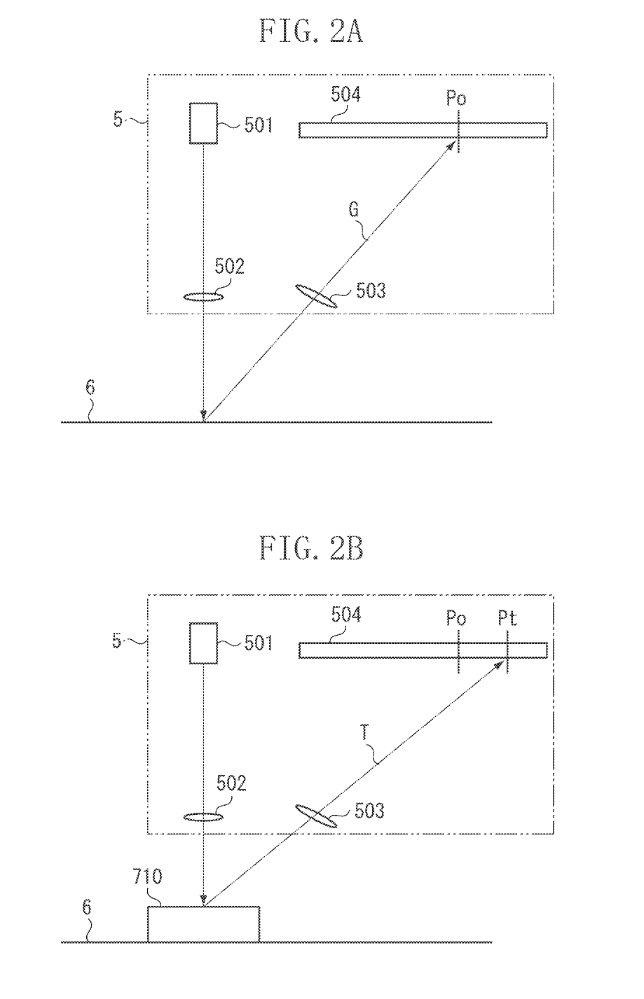

Next, a method for detecting the thickness of a patch image formed on the intermediate transfer belt 6 by the thickness detection unit 5 illustrated in FIG. 1 will be described with reference to FIGS. 2A, 2B, 3A, 3B, and 4.

FIGS. 2A and 2B are schematic diagrams of a main portion of the thickness detection unit 5 illustrated in FIG. 1. The intermediate transfer belt 6 moves in a direction from a front side of the figure to a far side.

The thickness detection unit 5 includes a laser oscillator 501, a condenser lens 502, and a light-receiving lens 503 as an irradiation unit as well as a line sensor 504 as a light-receiving unit.

The laser oscillator 501 emits a measuring beam (wavelength 850 nm) to the intermediate transfer belt 6 via the condenser lens 502 to form a light spot with a diameter of 200 μm.

The line sensor 504 includes a great number of light-receiving elements arranged in a row on the light-receiving face. Each light-receiving element of the line sensor 504 outputs a voltage corresponding to a light intensity of the received light. Further, each light-receiving element is arranged with such a pitch that even if the thickness of the patch image is changed for one toner particle of an average particle diameter, the change in the light-receiving position can be detected.

FIG. 2A illustrates a state of the main portion of the thickness detection unit 5. In this state, a patch image 710 is not in the exposure region which is exposed to the light from the laser oscillator 501. The measuring beam emitted from the laser oscillator 501 is reflected by the intermediate transfer belt 6 and received by the line sensor 504.

FIG. 2B illustrates a state of the main portion of the thickness detection unit 5 after the intermediate transfer belt 6 has moved in a direction from the front side of the figure to the far side. In this state, the patch image 710 is conveyed to the exposure region. The measuring beam emitted from the laser oscillator 501 is reflected by the patch image 710 and received by the line sensor 504.

Next, a light receiving method of the thickness detection unit 5 receiving the light reflected by the intermediate transfer belt 6 and the light reflected by the patch image 710 will be described.

First, as illustrated in FIG. 2A, when a measuring beam is emitted from the laser oscillator 501, the measuring beam is directed to the intermediate transfer belt 6 via the condenser lens 502. This measuring beam is reflected by the surface of the intermediate transfer belt 6. Then, the reflected light (reflected light G) enters the light-receiving lens 503. As a result, an image is formed at a light-receiving position Po on the line sensor 504. The reflected light G is a representation of a barycentric position of the light that passes through the center of the light-receiving lens 503, with respect to the light reflected by the intermediate transfer belt 6. Further, the reflected light other than the light that entered the light-receiving lens 503 is blocked by a shield (not illustrated).

Next, while the measuring beam is continuously emitted from the laser oscillator, the intermediate transfer belt 6 moves in the direction from the front side of the figure to the far side. Then, as illustrated in FIG. 2B, the patch image 710 carried by the intermediate transfer belt 6 enters the exposure region. When the patch image 710 reaches the exposure region, the measuring beam emitted from the laser oscillator 501 is reflected by the patch image 710. Then, the reflected light (reflected light T) enters the light-receiving lens 503. As a result, an image is formed at a light-receiving position Pt on the line sensor 504. The reflected light T is a representation of a barycentric position of the light that passes through the center of the light-receiving lens 503, with respect to the light reflected by the patch image 710. Further, the reflected light other than the light that entered the light-receiving lens 503 is blocked by a shield (not illustrated).

Next, a method for obtaining a light-receiving position difference ΔPt, which is a difference between the light-receiving position Po (the light-receiving position of the light reflected by the intermediate transfer belt 6) and the light-receiving position Pt (the light-receiving position of the light reflected by the patch image 710) will be described.

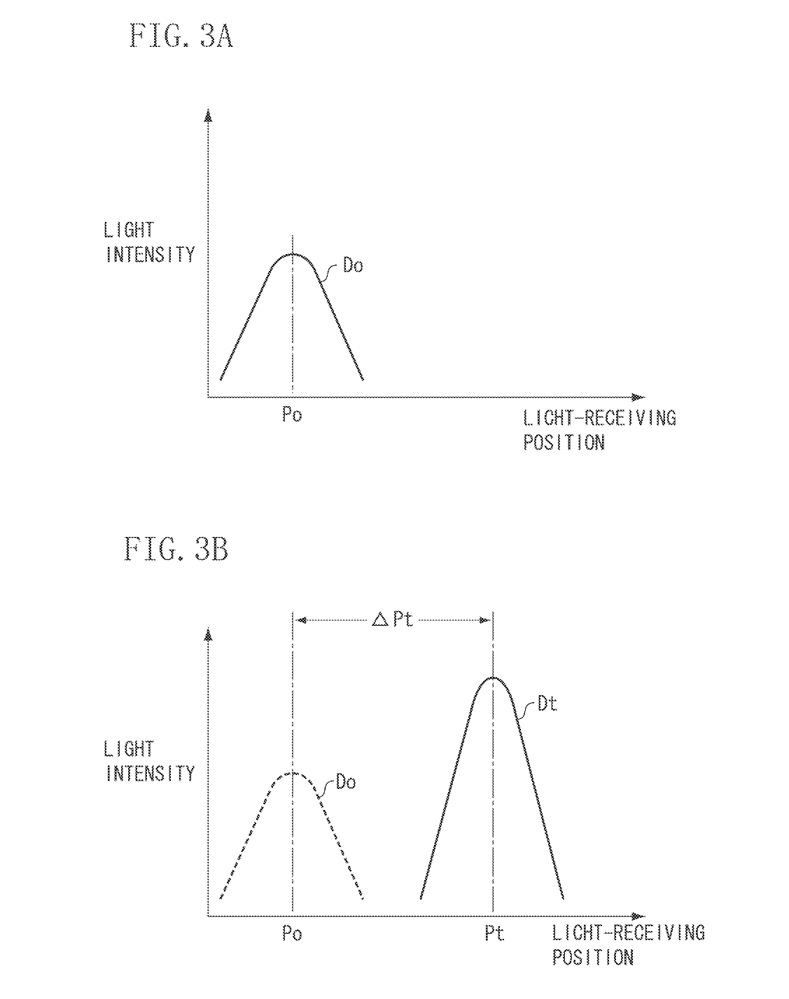

FIG. 3A illustrates a distribution (intensity distribution) of light intensity Do measured by the line sensor 504 illustrated in FIG. 2A. The light intensity Do is the intensity of the light reflected by the intermediate transfer belt 6 at the surface. According to the present embodiment, the light-receiving position Po of the light reflected by the intermediate transfer belt 6 corresponds to a position on the light-receiving face where the light intensity Do of the reflected light reaches the maximum value.

FIG. 3B illustrates a distribution (intensity distribution) of light intensity Dt measured by the line sensor 504 illustrated in FIG. 2B. The light intensity Dt is the intensity of the light reflected by the surface of the patch image 710. According to the present embodiment, the light-receiving position Pt of the light reflected by the patch image 710 corresponds to a position on the light-receiving face where the light intensity Dt of the reflected light reaches a maximum value. In FIG. 3B, the distribution of the light intensity Do of the light reflected by the surface of the intermediate transfer belt 6 illustrated in FIG. 2A is presented by a broken line.

In FIG. 3B, the difference between the light-receiving position Po of the light reflected by the intermediate transfer belt 6 and the light-receiving position Pt of the light reflected by the patch image 710 corresponds to the thickness of the patch image 710. Thus, according to the present embodiment, the thickness detection unit 5 detects the light-receiving position Po of the light reflected by the intermediate transfer belt 6 and the light-receiving position Pt of the light reflected by the patch image 710. Then, a patch image thickness Ht as the thickness of the patch image 710 is identified from the difference (the light-receiving position difference ΔPt) between the light-receiving position Po and the light-receiving position Pt.

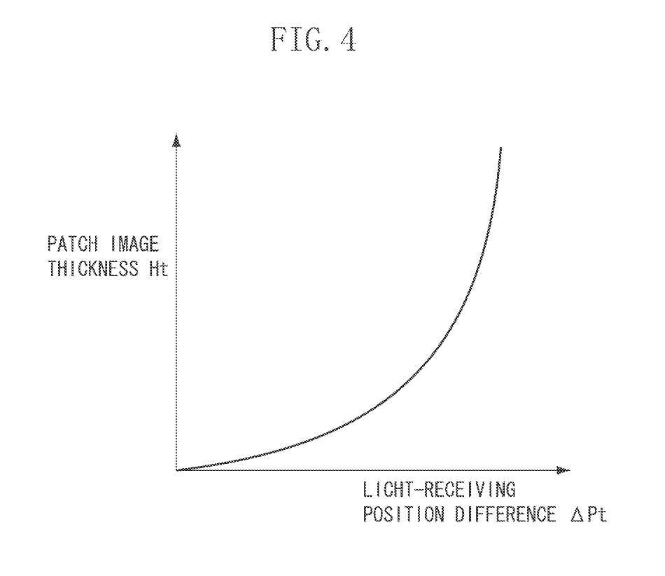

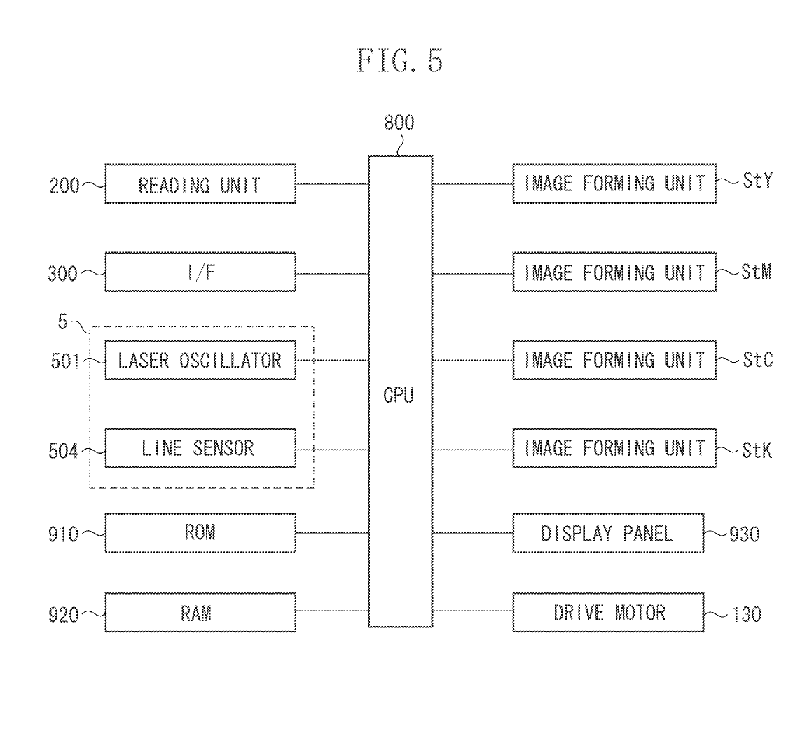

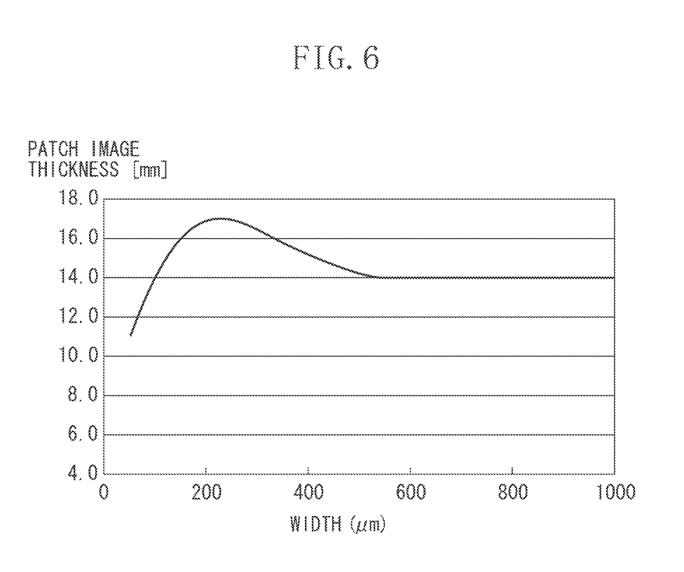

FIG. 4 illustrates data showing the relation between the light-receiving position difference ΔPt and the patch image thickness Ht. By comparing a light-receiving position difference with the data concerning the relation between the light-receiving position difference ΔPt and the patch image thickness Ht illustrated in FIG. 4, the thickness Ht of the patch image 710 can be identified. The data concerning the relation between the light-receiving position difference ΔPt and the patch image thickness Ht is stored in advance in a read-only memory (ROM) 910 (see FIG. 5) described below.

According to the present embodiment, a central processing unit (CPU) 800 (see FIG. 5) adjusts the image forming conditions so that the patch image thickness Ht is set to a thickness corresponding to a target density value. According to this adjustment, the image forming condition used for forming a toner image having a target density value can be determined. The image forming condition includes charge voltage of the charging devices 2Y, 2M, 2C, and 2K, the amount of exposure light and exposure time of the exposure units 3Y, 3M, 3C, and 3K, and developing bias of the developing units 4Y, 4M, 4C, and 4K.

Further, according to the present embodiment, although the line sensor 504 is used for detecting the light-receiving position of the light reflected by the intermediate transfer belt 6 and the light-receiving position of the light reflected by the patch image 710, an area sensor including a light-receiving face with light-receiving elements arranged in a two dimensional manner can be used in place of the line sensor.

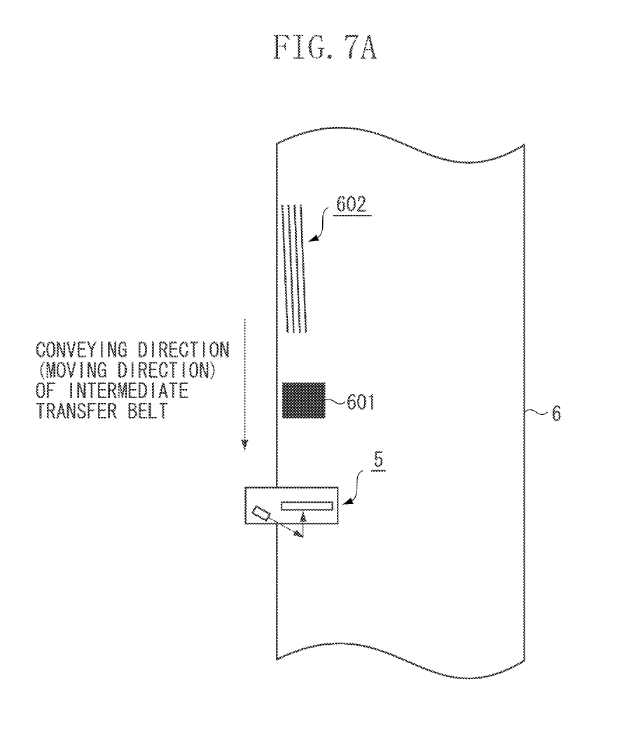

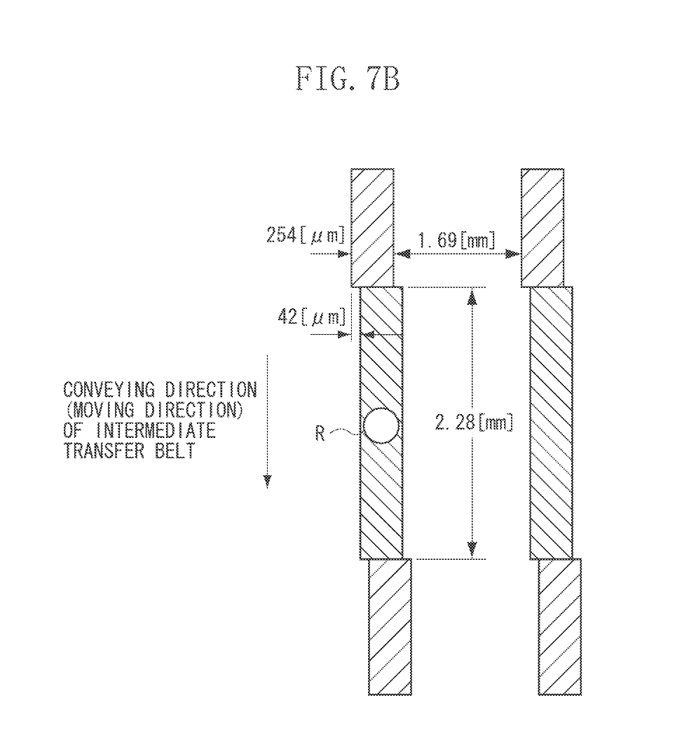

Regarding a patch image whose longitudinal direction is the same as the conveying direction of the intermediate transfer belt 6, if the width is shorter than a predetermined width, the patch image may not be conveyed to the position on the intermediate transfer belt 6 where the measuring beam emitted from the laser oscillator 501 is directed to. In such a case, the toner thickness may not be detected. Thus, according to the present embodiment, as described below with reference to FIG. 7, a plurality of patch images with a width thinner than a predetermined width are formed in a line in a direction perpendicular to the conveying direction of the intermediate transfer belt 6. In this manner, one of the patch images with the width thinner than a predetermined width can pass the position on the intermediate transfer belt 6 where the measuring beam emitted from the laser oscillator 501 is directed to. Accordingly, the thickness of the patch image can be detected.

FIG. 5 is a control block diagram of the image forming apparatus.

In FIG. 5, the CPU 800 is a control unit that controls the whole image forming apparatus. The ROM 910 is a storage unit. A control program used for controlling various types of processing executed by the image forming apparatus is stored in the ROM 910. Further, the image forming condition used for forming the patch image by the image forming units StY, StM, StC, and StK is stored in the ROM 910. This image forming condition is used for identifying the image forming condition of the image data. Furthermore, data considering the relation between the light-receiving position difference ΔPt and the patch image thickness Ht (see FIG. 4) and data considering relation between a mean thickness ratio Rave and a signal level upper limit Tr of a fine line area (see table 1) are stored in advance in the ROM 910. Further, a random access memory (RAM) 920 is a system work memory used for the processing executed by the CPU 800.

A reading unit 200 is a document reader. Image data obtained from a document according to a publicly-known configuration is transferred from the reading unit 200 to the CPU 800. An interface 300 transfers image data input from an external apparatus, such as a PC, to the CPU 800.

The laser oscillator 501 emits a measuring beam corresponding to a signal sent from the CPU 800. The measuring beam is directed to the intermediate transfer belt 6. The line sensor 504 receives the light reflected by the intermediate transfer belt 6 or receives the light reflected by the patch image, and outputs a voltage from each light-receiving element corresponding to the light intensity. The CPU 800 detects the position of the light-receiving element that outputs the maximum voltage value as the light-receiving position of the reflected light. The maximum voltage value is determined from the voltage values corresponding to the light intensity output from the light-receiving elements of the line sensor 504.

According to an instruction from the CPU 800, each of the image forming units StY, StM, StC, and StK forms a toner image of the corresponding color component on the intermediate transfer belt 6 by using the image forming condition stored in the ROM 910 or the RAM 920.

A display panel 930 includes a liquid crystal screen used for displaying abnormality of the image forming apparatus. When the display panel receives a signal indicating abnormality of the image forming apparatus from the CPU 800, the content of the abnormality is displayed on the screen.

A drive motor 130 is a stepping motor. When a current corresponding to a signal transferred from the CPU 800 is applied to the drive motor 130, a drive roller 13 illustrated in FIG. 1 starts to rotate. Then, the intermediate transfer belt 6 illustrated in FIG. 1 is driven to the direction of the arrow C according to the rotation of the drive roller 13.

According to the present embodiment, an image forming condition used for forming a toner image of a predetermined density is determined based on a thickness of a patch image with a width wider than a predetermined width. This image forming condition is set to such a condition that when the toner images of each color component are superimposed, (a) a total of the signal levels of a same pixel position is smaller than or equal to a threshold value and (b) the toner scattering does not occur even when a toner image which is wider than a predetermined width is deteriorated due to environmental change or developer deterioration. According to the present embodiment, the signal level corresponds to the gradation data of each pixel when a toner image corresponding to the image data is formed, and is a parameter that changes the toner amount.

Further, if a total of the signal levels of a same pixel position exceeds a threshold value, even if the width of the toner image is wider than a predetermined width, the toner scattering occurs. Thus, if a total of the signal levels of a same pixel position exceeds an upper limit of a signal level that causes the toner scattering, the signal level of each color component is corrected so that the total of the signal levels is within the upper limit.

In this manner, the image forming units StY, StM, StC, and StK can control the toner image to such thickness that when a toner image corresponding to image data whose signal level has been corrected is formed, the thickness of the toner image is smaller than or equal to a target thickness that can prevent the occurrence of toner scattering.

According to an experiment, the toner scattering occurred when a toner image obtained by superimposing the toner images, thicker than 35 μm, of each color component is fixed. If a toner image of a single color is formed by the maximum signal level, its thickness is 14 μm. Thus, it is understood that the toner scattering occurs when the toner images of the maximum density corresponding to 2.5 colors or more are superimposed.

According to the present embodiment, the signal level is expressed in 101 levels from 0 to 100. The signal level of a single color toner image formed at its maximum density is set to level 100. In other words, the total signal level will be 400 if the toner images of four colors with the maximum density are superimposed.

According to the present embodiment, the signal level of each color component is corrected according to equations 1 to 4 below so that the total of the signal levels when the toner images of each color component are superimposed is 250 or lower. Regarding the equations 1 to 4, the signal level of each color component is multiplied by the ratio of a total of the signal levels of each color component with respect to the upper limit so that a total of the signal levels of each color component is within the upper limit.

$$\begin{matrix}Y 1 = \frac{Tr}{Y 0 + M 0 + C 0 + K 0} * Y 0 , ( Y 0 + M 0 + C 0 + K 0 \geq 250 ) & ( equation 1 ) \\ M 1 = \frac{Tr}{Y 0 + M 0 + C 0 + K 0} * M 0 , ( Y 0 + M 0 + C 0 + K 0 \geq 250 ) & ( equation 2 ) \\ C 1 = \frac{Tr}{Y 0 + M 0 + C 0 + K 0} * C 0 , ( Y 0 + M 0 + C 0 + K 0 \geq 250 ) & ( equation 3 ) \\ K 1 = \frac{Tr}{Y 0 + M 0 + C 0 + K 0} * K 0 , ( Y 0 + M 0 + C 0 + K 0 \geq 250 ) & ( equation 4 )\end{matrix}$$

Regarding the equations 1 to 4, the signal level upper limit Tr denotes the upper limit of the signal level when the toner images of each color component (yellow, magenta, cyan, and black) are superimposed. Regarding the equations 1 to 4, the signal level upper limit Tr will be 250 if the thickness is controlled to a thickness corresponding to 2.5 colors in a state a plurality of toner images are superimposed.

Further, regarding the equations 1 to 4, Y0 is a signal level used for forming a yellow toner image before the correction, M0 is a signal level used for forming a magenta toner image before the correction, C0 is a signal level used for forming a cyan toner image before the correction, and K0 is a signal level used for forming a black toner image before the correction.

Further, in the equation 1, Y1 is a signal level used for forming a yellow toner image after the correction. The signal level Y1 is obtained by dividing the signal level upper limit Tr by a total of the signal levels of each color component before the correction, and multiplying the obtained value by a signal level of a yellow toner image before the correction is performed.

Similarly, regarding the equation 2, M1 is a signal level used for forming a magenta toner image after the correction. The signal level M1 is obtained by dividing the signal level upper limit Tr by a total of the signal levels of each color component before the correction, and multiplying the obtained value by a signal level of a magenta toner image before the correction is performed.

Further, regarding the equation 3, C1 is a signal level used for forming a cyan toner image after the correction. The signal level C1 is obtained by dividing the signal level upper limit Tr by a total of the signal levels of each color component before the correction, and multiplying the obtained value by a signal level of a cyan toner image before the correction is performed.

Furthermore, regarding the equation 4, K1 is a signal level used for forming a black toner image after the correction. The signal level K1 is obtained by dividing the signal level upper limit Tr by a total of the signal levels of each color component before the correction, and multiplying the obtained value by a signal level of a black toner image before the correction is performed.

Next a case where a fine line toner image with a line width of 0.3 mm is formed by the signal levels of yellow 90, magenta 80, cyan 70, and black 30 (total signal level is 270) will be described. If the upper limit of the total of the signal levels of this toner image is 250, the signal level upper limit Tr of the total signal level will be 250. Thus, according to the equations 1 to 4, the signal levels are corrected to yellow 83, magenta 74, cyan 65, and black 28.

According to the present embodiment, the CPU 800 does not perform the correction of the signal level if the total of the signal levels of each color component is 250 or lower.

However, even if the signal levels of each color component are corrected so that the total of the signal levels is 250 or lower, in some cases, toner scattering of a character or a line image occurs. Thus, according to the present embodiment, the CPU 800 determines the image forming condition appropriate for forming a toner image with a width shorter than or equal to a predetermined width based on a thickness of a patch image whose longitudinal direction is the same as the conveying direction of the intermediate transfer belt 6 and with a width shorter than or equal to the predetermined width.

If this determined image forming condition is used, the thickness of a toner image having the longitudinal direction same as the conveying direction of the intermediate transfer belt 6 and with a width shorter than a predetermined width can be controlled to have a value smaller than or equal to a threshold value that prevents the toner scattering. Further, if this determined image forming condition is used, the thickness of a toner image having the longitudinal direction perpendicular to the conveying direction of the intermediate transfer belt 6 and with a width shorter than a predetermined width can be controlled to have a value smaller than or equal to a threshold value that prevents the toner scattering

FIG. 6 is a graph illustrating a result of thickness detection of a plurality of toner images with different lengths in the direction perpendicular to the conveying direction of the intermediate transfer belt 6. The toner images are straight line toner images formed lengthwise in the conveying direction of the intermediate transfer belt 6 by an image forming apparatus with a recording resolution of 600 dpi. The length of the toner images corresponds to 600 pixels in the conveying direction of the intermediate transfer belt 6. Further, the width of the toner images in the direction perpendicular to the conveying direction is changed from 1 to 24 pixels in 1 pixel steps. Regarding an image forming apparatus with a recording resolution of 600 dpi, 1 pixel is approximately 42 μm.

According to FIG. 6, it is understood that the thickness of the toner images with a width of 150 to 300 μm in the direction perpendicular to the conveying direction of the intermediate transfer belt 6 is increased by 20% or greater compared to a toner image with a width greater than 500 μm. The thickness of the toner image is changed according to temperature, humidity, and a charge amount of toner.

Thus, according to the present embodiment, the CPU 800 forms a fine line patch image with a width of 500 μm in the widthwise direction for each color component and detects the thickness of this fine line patch image. Next, according to the thickness of the fine line toner image, the CPU 800 changes the signal level upper limit Tr of the total of the signal levels used for forming characters and fine line portions of a toner image when a plurality of toner images are superimposed to form an image. Thus, fine line toner images with a width of 500 μm or less are corrected in such a manner that the signal level is within an upper limit different from the upper limit of a signal level of a toner image with a width greater than 500 μm. In this manner, the thickness of the toner images with a width of 500 μm or less is controlled to a value smaller than or equal to a threshold value that can prevent the toner scattering.

Next, a method for identifying the signal level upper limit Tr which is used when a toner image with a width of 500 μm or less is formed will be described.

First, the CPU 800 forms a solid patch image with the maximum density for each color component. Next, the CPU 800 adjusts the image forming condition so that a patch image thickness Ht1 of each solid patch image corresponds to the maximum density. The solid patch image is an image where the toner is uniformly carried on the toner image. A thickness Ht1y is a thickness of a yellow solid patch image, a thickness Ht1m is a thickness of a magenta solid patch image, a thickness Ht1c is a thickness of a cyan solid patch image, and a thickness Ht1k is a thickness of a black solid patch image.

Next, the CPU 800 forms a fine line patch image for each color component by using the image forming condition where each value of the thicknesses Ht1y, Ht1m, Ht1c, and Ht1k of each solid patch image corresponds to the maximum density. Next, the CPU 800 obtains thicknesses Ht2y, Ht2m, Ht2c, and Ht2k of the fine line patch images of the color components. The thickness Ht2y is a thickness of a yellow fine line patch image, the thickness Ht2m is a thickness of a magenta fine line patch image, the thickness Ht2c is a thickness of a cyan fine line patch image, and the thickness Ht2k is a thickness of a black fine line patch image.

Next, the CPU 800 calculates ratios of the thicknesses Ht2y, Ht2m, Ht2c, and Ht2k of the fine line patch images with respect to the thicknesses Ht1y, Ht1m, Ht1c, and Ht1k of the solid patch images according to equations 5 to 8.

Ry=Ht2y/Ht1y (equation 5)

Rm=Ht2m/Ht1m (equation 6)

Rc=Ht2c/Ht1c (equation 7)

Rk=Ht2k/Ht1k (equation 8)

In the equation 5, a thickness ratio Ry is a thickness ratio of the thickness Ht2y of a yellow fine line patch image to the thickness Ht1y of a yellow solid patch image. Further, in the equation 6, a thickness ratio Rm is a thickness ratio of the thickness Ht2m of a magenta fine line patch image to the thickness Ht1m of a magenta solid patch image.

In the equation 7, a thickness ratio Rc is a ratio of the thickness Ht2c of a cyan fine line patch image to the thickness Ht1c of a cyan solid patch image. Further, in the equation 8, a thickness ratio Rk is a thickness ratio of the thickness Ht2k of a black fine line patch image to the thickness Ht1k of a black solid patch image. Further, according to experiments, each of the thickness ratios Ry, Rm, Rc, and Rk changes in the range between 1 and 2.5.

Further, a mean thickness ratio Rave is obtained according to the equation 9 below using the thickness ratio Ry of a yellow toner patch image, the thickness ratio Rm of a magenta toner patch image, the thickness ratio Rc of a cyan toner patch image, and the thickness ratio Rk of a black toner patch image. In the description below, the mean thickness ratio Rave is used for identifying the signal level upper limit Tr which is the upper limit of the signal level when the toner images of each color component are superimposed to form a toner image.

Rave=(Ry+Rm+Rc+Rk)/4 (equation 9)

Since the toner scattering occurs when the toner images of each color component (yellow, magenta, cyan, and black) are superimposed, according to the present embodiment, the CPU 800 obtains the signal level upper limit Tr from the mean thickness ratio Rave. The mean thickness ratio Rave is, as described above, a mean value of the thickness ratios Ry, Rm, Rc, and Rk of the toner images of each color component.

Table 1 below shows data of the relation between the signal level upper limit Tr of a fine line area and the mean thickness ratio Rave. The signal level upper limit Tr is a maximum signal value that does not cause toner scattering. The signal level upper limit Tr has been determined according to experiments performed by the inventors of the present invention.

The fine line area is the area of the characters or the line images that carries the toner with a width smaller than or equal to a predetermined width. According to the present embodiment, the CPU 800 determines a character of 14 point or smaller and a line with a width of 500 μm or less as the fine line area.

Further, the signal level upper limit Tr of the area where the toner is carried with a width of 500 μm or more is set to 250. The reason for setting the signal level upper limit Tr to 250 regarding an area where the width that carries the toner is 500 μm or more is that even if environmental change or developer deterioration occurs, the thickness of the toner image with a width of 500 μm or more is not increased to a level that causes the toner scattering.

The CPU 800 sets the signal level upper limit Tr of a fine line area corresponding to the mean thickness ratio Rave according to the data in table 1. For example, if the mean thickness ratio Rave is greater than 1.0 and smaller than or equal to 1.2, the CPU 800 sets the signal level upper limit Tr of a fine line area to 240. Further, for example, if the mean thickness ratio Rave is greater than 1.2 and smaller than or equal to 1.4, the CPU 800 sets the signal level upper limit Tr of a fine line area to 230.

TABLE 1

| | The signal level upper limit Tr |
|---|---|
| Mean thickness ratio Rave | of a fine line area |
| 1.0 | 250 |
| 1.2 | 240 |
| 1.4 | 230 |
| 1.6 | 220 |
| 1.8 | 210 |
| 2.0 | 200 |

Next, a solid patch image 601 of black toner and a fine line patch image 602 of black toner, which are formed when the image forming unit StK obtains the thickness ratio Rk of a black toner image, will be described. FIG. 7A is an overall view of the solid patch image 601 and the fine line patch image 602 formed on the intermediate transfer belt 6. FIG. 7B is an enlarged view of a portion of the patch image 602.

In FIG. 7A, the solid patch image 601 of black toner formed on the intermediate transfer belt 6 as an image carrier is 8 mm long in the conveying direction of the intermediate transfer belt 6 and 8 mm wide in the direction perpendicular to the conveying direction. Both the lengths of the solid patch image 601 in the conveying direction of the intermediate transfer belt 6 and in the direction perpendicular to the conveying direction are longer than 500 μm.

Further, patterns including the fine line patch images are formed in the conveying direction of the intermediate transfer belt 6. To be more precise, 40 patterns of fine line patch images are arranged in the conveying direction of the intermediate transfer belt 6. Each pattern includes four fine line patch images 602 which are arranged in a direction perpendicular to the conveying direction. The fine line patch images 602 are formed in such a manner that even if the intermediate transfer belt 6 moves in the direction perpendicular to the conveying direction of the intermediate transfer belt 6, one of the fine line patch images 602 reaches an exposure region R.

According to the arrangement of the fine line patch images 602, the possibility of the fine line patch image 602 passing a position off the exposure region (exposure region R in FIG. 7B) on the intermediate transfer belt 6 where the light emitted from the laser oscillator 501 is directed to can be reduced. Thus, the thickness Ht2 of the fine line patch image 602 can be reliably detected. According to the present embodiment, the patterns of a plurality of the fine line patch images 602 arranged in the conveying direction of the intermediate transfer belt 6 are formed by shifting a length corresponding to one pixel (42 μm) to one side of the patch images in the direction perpendicular to the conveying direction. In this manner, since one of the fine line patch images 602 reaches the exposure region R, the CPU 800 can detect the thickness Ht2 of the fine line patch image 602.

The fine line patch image 602 formed on the intermediate transfer belt 6 is 2.28 mm long in the conveying direction of the intermediate transfer belt 6 and 254 μm wide in the direction perpendicular to the conveying direction. Further, the longitudinal direction of the fine line patch image 602 is the same as the conveying direction of the intermediate transfer belt 6.

According to the present embodiment, the width (254 μm) of the fine line patch image 602 in the direction perpendicular to the conveying direction of the intermediate transfer belt 6 is equal to the width corresponding to 6 pixels of the image forming apparatus with the recording resolution of 600 dpi. Further, the spot diameter of the exposure region R on the intermediate transfer belt 6 which is exposed to the laser beam emitted from the laser oscillator 501 is 200 μm. Thus, the spot diameter is smaller than the width of the fine line patch image 602.

According to the present embodiment, the solid patch image 601 and the fine line patch image 602 of the above-described dimensions are also formed on the intermediate transfer belt 6 for the yellow, magenta, and cyan color components. The data of the dimensions of the solid patch image 601 and the fine line patch image 602 is stored in the ROM 910. The ROM 910 functions as a storage unit of the image data for the toner image for measurement.

Further, according to the present embodiment, although the width of the fine line patch image 602 of each color component in the widthwise direction is set to a width corresponding to 6 pixels, the width is not limited so long as it is 500 μm or less which is the width that causes toner scattering. If the width of the fine line patch image is set to 6 pixels, first, the total of the signal levels of each color component is corrected to a value smaller than or equal to the signal level upper limit Tr to form a fine line toner image with a width corresponding to 6 pixels. Then, a relation between the signal level upper limit Tr and the mean thickness ratio Rave is set so that toner scattering of the fine line toner image does not occur.

The fine line toner image with the width corresponding to 6 pixels is used as a reference image according to experiment results. In other words, when a number of fine line toner images with different widths were formed under the same image forming condition, the fine line toner image with the width corresponding to 6 pixels produced the thickest toner image. Thus, the fine line toner image that produces the thickest toner image with the highest possibility of causing the toner scattering has been selected as the reference fine line toner image.

Further, the solid patch image 601 and the fine line patch image 602 can be formed with the maximum density. If the density of the toner image formed on the intermediate transfer belt 6 by area coverage modulation is increased, in other words, if the signal level is increased, the surface becomes smooth. Thus, the patch image formed at signal level 100 is useful in identifying the above-described light-receiving position more accurately compared to a patch image formed at a signal level lower than 100. By using a patch image formed at signal level 100, the mean thickness ratio Rave can be accurately calculated from the thicknesses Ht1y, Ht1m, Ht1c, and Ht1k of the solid patch images of each color component and the thicknesses Ht2y, Ht2m, Ht2c, and Ht2k of the fine line patch images of each color component.

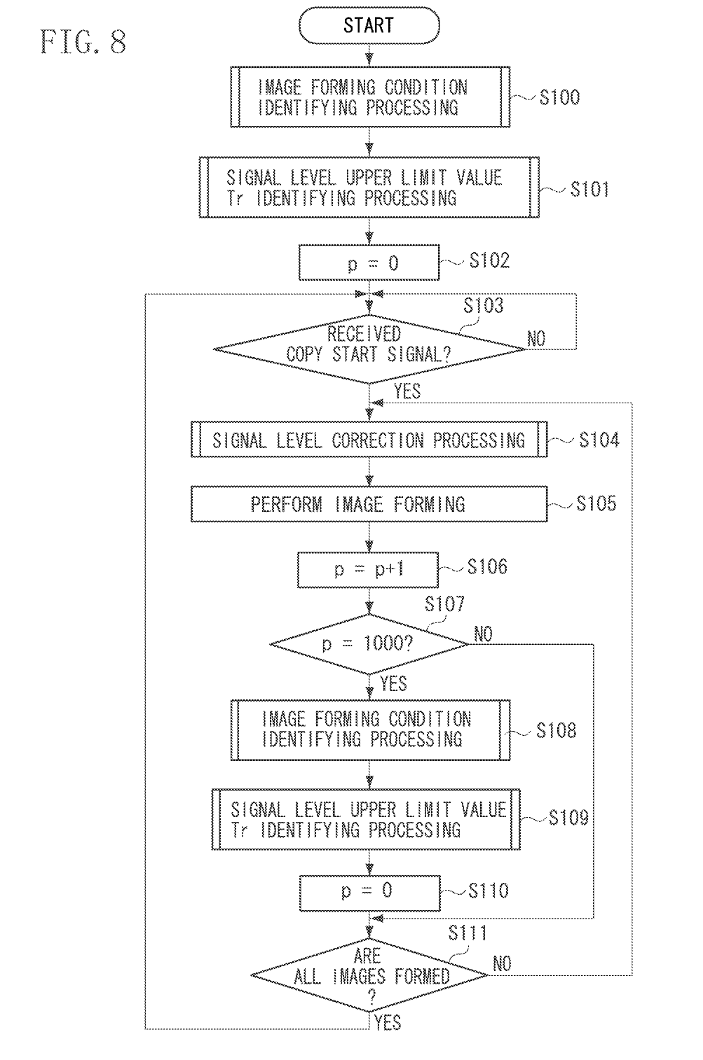

FIG. 8 is a flowchart illustrating the operation of the CPU 800 (see FIG. 5) when the image forming apparatus forms an image. Processing of the flowchart in FIG. 8 is realized by the CPU 800 reading out a program stored in the ROM 910 (see FIG. 5) and executing it.

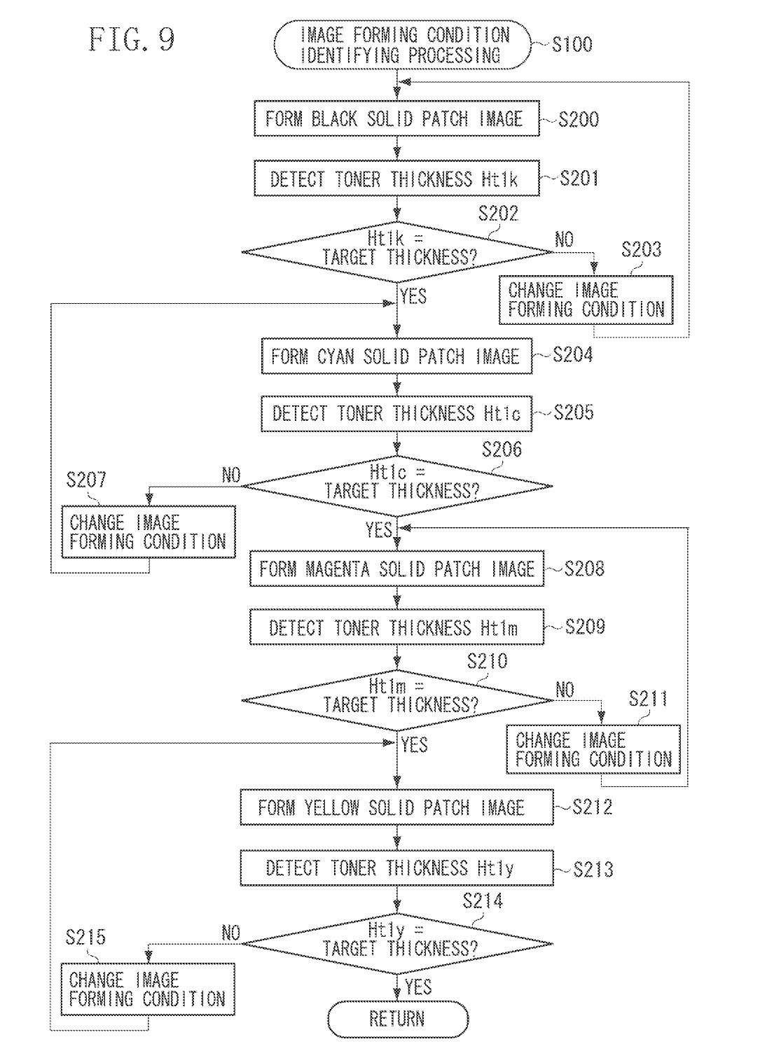

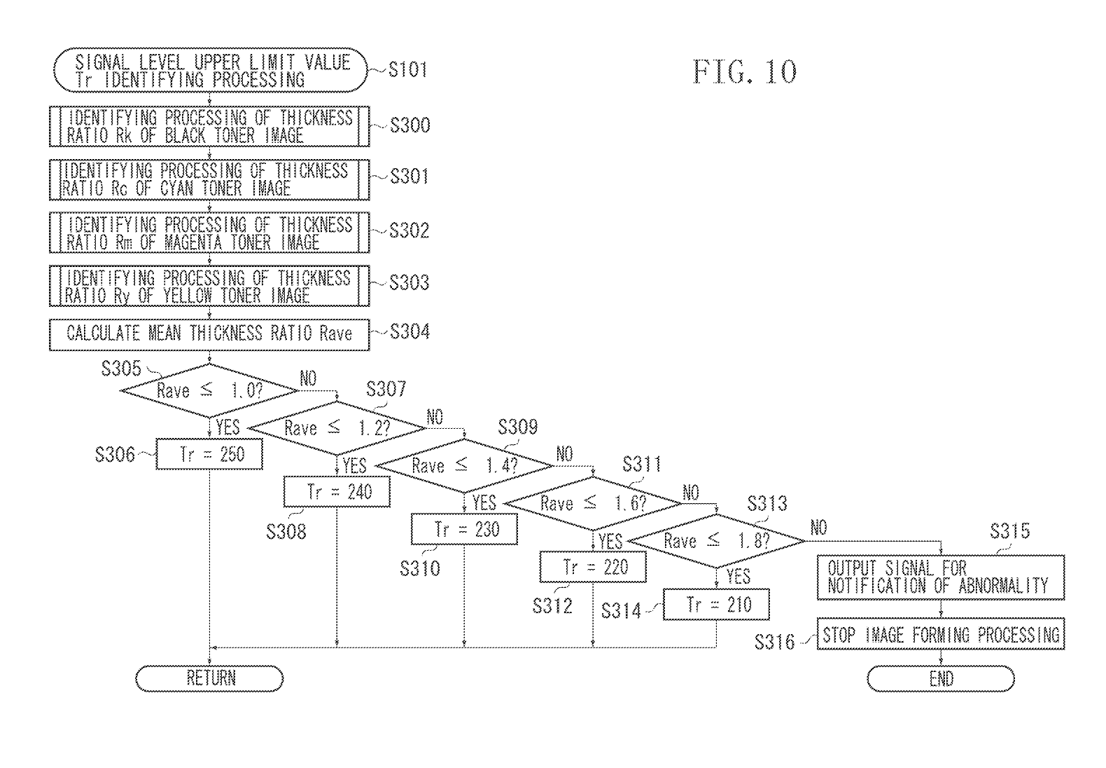

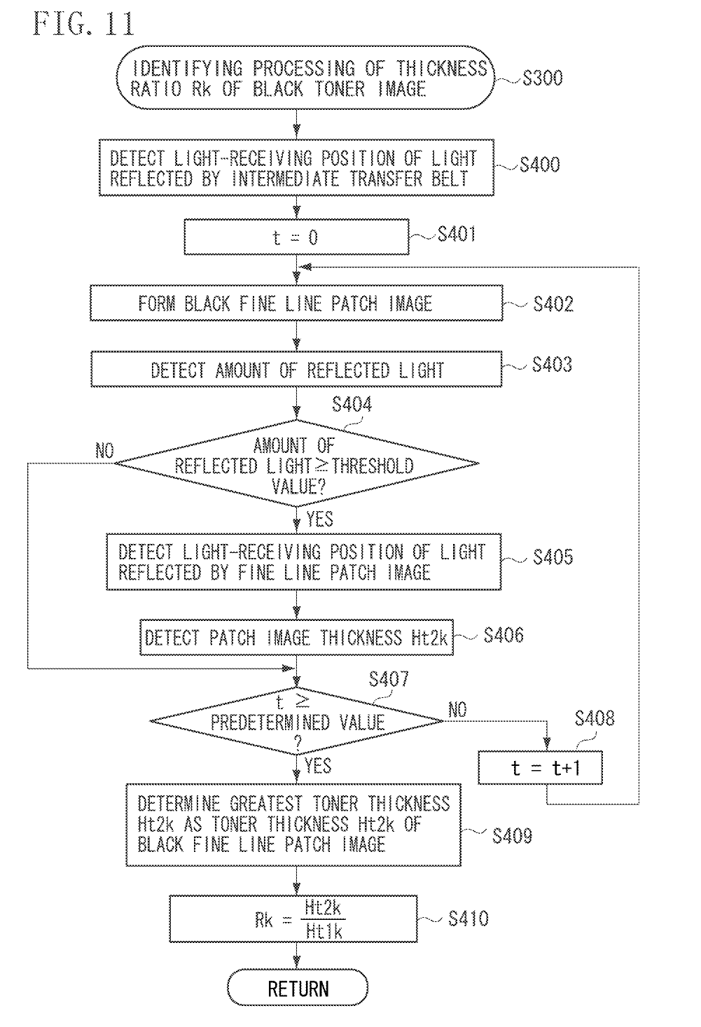

In step S100, when the main power supply of the image forming apparatus is turned on, the CPU 800 performs the image forming condition determining processing. In step S101, the CPU 800 determines the signal level upper limit Tr as the upper limit of the signal level when the toner images of each color component are superimposed. In step S102, the CPU 800 resets a page count value p to 0. The image forming condition determining processing in step S100 is described below with reference to FIG. 9. Further, the identifying processing of the signal level upper limit Tr in step S101 is described below with reference to FIG. 10.

In step S103, the CPU 800 determines whether a copy start signal has been input. If the CPU 800 determines that a copy start signal has been input (YES in step S103), the processing proceeds to step S104. In step S104, when image data is input from an external apparatus such as a PC via the interface 300, the CPU 800 performs the signal level correction processing.

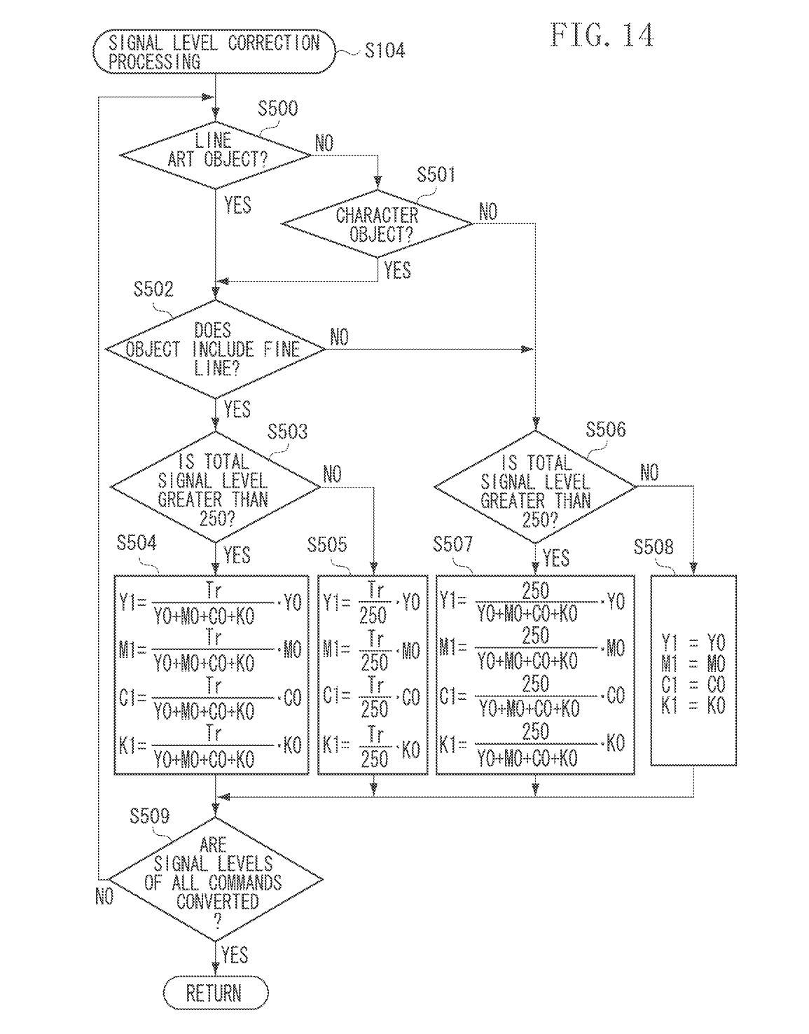

According to the present embodiment, although the CPU 800 corrects the signal level of the image data transferred from the interface 300, the CPU 800 can correct the signal level of the image data of a document read by the reading unit 200. In step S104, the interface 300 or the reading unit 200 functions as an input unit that inputs image data. Since the signal level correction processing in step S104 is described below with reference to FIG. 14, detailed descriptions will be omitted.

In step S105, the CPU 800 performs the image forming processing by the image forming units StY, StM, StC, and StK. In other words, the CPU 800 instructs the image forming units StY, StM, StC, and StK to form a toner image based on a signal level corrected in step S104. The toner image of each color component is superimposed on the intermediate transfer belt 6 (see FIG. 1). In step S105, the image forming units StY, StM, StC, and StK function as image forming units forming a toner image of each color component on the intermediate transfer belt 6 as an image carrier. In step S106, the CPU 800 increments the page count value p by 1 each time image forming processing of one sheet is performed.

In step S107, the CPU 800 determines whether the page count value p is 1000. If the page count value p is not 1000 yet (NO in step S107), the processing proceeds to step S111.

In step S111, the CPU 800 determines whether all the images corresponding to the input image data have been formed. If all the images corresponding to the input image data have not been formed yet (NO in step S111), the processing returns to step S104 and the signal level correction processing is performed. On the other hand, in step S111, if all the images corresponding to the input image data have been formed (YES in step S111), the processing returns to step S103, and the CPU 800 waits until the user inputs a signal for starting the copy operation.

In step S107, if the CPU 800 determines that the page count value p has reached 1000 (YES in step S107), the processing proceeds to step S108. In step S108, the CPU 800 performs the determining processing of the image forming condition. In step S109, the CPU 800 performs the identifying processing of the signal level upper limit Tr. In step S110, the CPU 800 resets the page count value p to 0.

According to the present embodiment, the CPU 800 executes the determining processing of the image forming condition and the identifying processing of the signal level upper limit Tr each time image forming of 1000 sheets is performed. Further, the CPU 800 can execute the processing each time the image forming of a number of sheets that is considered to produce thicker fine line toner image due to deterioration of the developer is performed. Further, the CPU 800 can execute the processing when a sensor (not illustrated) detects that temperature or humidity regarding the image forming apparatus has changed exceeding a predetermined value. Further, the CPU 800 can execute the above-described processing according to an instruction from the user.

Since the processing in step S108 is similar to the processing in step S100, details of the processing will be described below with reference to the determining processing of the image forming condition with reference to FIG. 9. Further, since the processing in step S109 is similar to the processing in step S101, details of the identifying processing of the signal level upper limit Tr will be described below with reference to FIG. 10.

After step S110, the processing proceeds to step S111. The processing in step S111 is described above.

Next, the determining processing of the image forming condition executed in steps S100 and S108 in FIG. 8 will be described with reference to the flowchart in FIG. 9. Processing in step S108 is similar to the processing in step S100. Further, the processing of this flowchart is realized by the CPU 800 reading out and executing a program stored in the ROM 910. In the following description, the solid patch images 601 of the yellow, magenta, cyan, and black color components are denoted as a yellow solid patch image 601y, a magenta solid patch image 601m, a cyan solid patch image 601c, and a black solid patch image 601k.

In step S200, the CPU 800 instructs the image forming unit StK to form the black solid patch image 601k on the intermediate transfer belt 6 by using the image forming condition stored in the ROM 910. In step S201, from the black solid patch image 601k formed on the intermediate transfer belt 6, the CPU 800 detects the thickness Ht1k of the black solid patch image 601k by the laser oscillator 501 and the line sensor 504. The length of the black solid patch image 601k carried on the intermediate transfer belt 6 in the direction perpendicular to the conveying direction of the intermediate transfer belt 6 is 8 mm. Thus, even if the intermediate transfer belt 6 moves 1 mm to the direction perpendicular to the conveying direction of the intermediate transfer belt 6, the black solid patch image 601k can pass the exposure region.

According to the present embodiment, the time elapsed from the start of the formation of the black solid patch image 601k is measured. Thus, the light-receiving position of the light reflected by the black solid patch image 601k is detected at the timing the black solid patch image 601k reaches the exposure region with reliability. The timing the black solid patch image 601k reaches the exposure region is measured in advance and the data is stored in the ROM 910.

In step S202, the CPU 800 determines whether the thickness Ht1k of the black solid patch image 601k detected in step S201 is equal to a target thickness of the black solid patch image 601k stored in advance in the ROM 910. According to the present embodiment, the target thickness when the black solid patch image 601k is formed at the maximum density is 14 μm. This target thickness is the thickness of a toner image when a toner image with the density measured by X-rite 504 spectrodensitometer is 1.6 (corresponding to the maximum density) is formed. The thickness of the formed toner image is detected by the thickness detection unit 5.

In step S202, if the thickness Ht1k of the black solid patch image 601k is not yet the target thickness (NO in step 5202), the processing proceeds to step S203. In step S203, the CPU 800 changes the image forming condition of the image forming unit StK, and then the processing returns to step S200. In step S203, after changing the image forming condition of the image forming unit StK, the CPU 800 stores the changed image forming condition in the RAM 920. Further, in step S200, the CPU 800 instructs the image forming unit StK to form the black solid patch image 601k again by using the image forming condition changed in step S203.

By repeating the processing in steps S200 to S203, the CPU 800 continues to form the black solid patch image 601k until the thickness Ht1k reaches the target thickness while changing the image forming condition. According to the present embodiment, although the CPU 800 determines the image forming condition used for forming a toner image of the maximum density based on the thickness Ht1k of the black solid patch image 601k, the CPU 800 can form a plurality of the black solid patch images 601k with different density and determine an image forming condition for forming all gradation data.

On the other hand, in step S202, if the thickness Ht1k of the black solid patch image 601k reaches the target thickness (YES in step S202), the processing proceeds to step S204. In step S204, the CPU 800 instructs the image forming unit StC to form the cyan solid patch image 601c on the intermediate transfer belt 6 by using the image forming condition stored in the ROM 910.

In step S205, from the cyan solid patch image 601c formed on the intermediate transfer belt 6, the CPU 800 detects the thickness Ht1c of the cyan solid patch image 601c by the laser oscillator 501 and the line sensor 504. The method for detecting the thickness Ht1c of the cyan solid patch image 601c is the same as the method used for detecting the thickness Ht1k of the black solid patch image 601k described above.

In step S206, the CPU 800 determines whether the thickness Ht1c of the cyan solid patch image 601c detected in step S205 is equal to a target thickness of the cyan solid patch image 601c stored in advance in the ROM 910. According to the present embodiment, the target thickness when the cyan solid patch image 601c is formed at the maximum density is 14 μm. In step S206, if the thickness Ht1c of the cyan solid patch image 601c is not yet the target thickness (NO in step S206), the processing proceeds to step S207. In step S207, the CPU 800 changes the image forming condition of the image forming unit StC, and then the processing returns to step S204.

In step S207, after changing the image forming condition of the image forming unit StC, the CPU 800 stores the changed image forming condition in the RAM 920. Further, in step S204, by using the image forming condition changed in step S207, the CPU 800 forms the cyan solid patch image 601c again by the image forming unit StC. By repeating the processing in steps S204 to S207, the cyan solid patch image 601c is continuously formed while the image forming condition is changed until the thickness Ht1c of the cyan solid patch image 601c reaches the target thickness.

On the other hand, in step S206, if the thickness Ht1c of the cyan solid patch image 601c reaches the target thickness (YES in step S206), the processing proceeds to step S208 and the CPU 800 performs the determining processing of the image forming condition used for forming the magenta solid patch image 601m at the maximum density.

In steps S208 to S211, the CPU 800 instructs the image forming unit StM to form the magenta solid patch image 601m until the thickness Ht1m of the magenta solid patch image 601m reaches the target thickness while changing the image forming condition. The target thickness is the thickness of the magenta solid patch image 601m when it is formed at the maximum density and is set to 14 μm. Since the processing in steps S208 to S211 is similar to the determining processing of the image forming condition used for forming a maximum density toner image by the above-described image forming units StK (black) and StC (cyan), detailed descriptions are not repeated.

In step S210, if the thickness Ht1m of the magenta solid patch image 601m reaches the target thickness (YES in step S210), the processing proceeds to step S212 and the CPU 800 performs the determining processing of the image forming condition used for forming the yellow solid patch image 601y at the maximum density.

In steps S212 to S215, the CPU 800 instructs the image forming unit StY to form the yellow solid patch image 601y until the thickness Ht1y of the yellow solid patch image 601y reaches the target thickness while changing the image forming condition. The target thickness is the thickness of the yellow solid patch image 601y when it is formed at the maximum density and is set to 14 μm. Since the processing in steps S212 to S215 is similar to the determining processing of the image forming condition used for forming a toner image by the above-described image forming units StK (black), StC (cyan), and StM (magenta), detailed descriptions are not repeated.

The determining processing of the image forming condition ends when the CPU 800 determines the image forming condition which is used when the image forming unit StY forms a yellow toner image. In this processing, the CPU 800 functions as a first determining unit determining an image forming condition used for forming a toner image of each color component.

Next, the identifying processing of the signal level upper limit Tr executed in steps S101 and S109 in FIG. 8 will be described with reference to the flowchart in FIG. 10. Processing in step S109 is similar to the processing in step S101. The processing of this flowchart is realized by the CPU 800 reading out a program stored in the ROM 910 and executing it.

In step S300, the CPU 800 performs identifying processing of the thickness ratio Rk of a black toner image. In step S301, the CPU 800 performs identifying processing of the thickness ratio Rc of a cyan toner image. In step S302, the CPU 800 performs identifying processing of the thickness ratio Rm of a magenta toner image. In step S303, the CPU 800 performs identifying processing of the thickness ratio Ry of a yellow toner image. Details of the identifying processing of the thickness ratios Ry, Rm, Rc, and Rk will be described below with reference to FIG. 11.

In step S304, the CPU 800 calculates the mean thickness ratio Rave from the thickness ratios Ry, Rm, Rc, and Rk identified in steps S300 to S303 according to the above-described equation 9. In step S305, the CPU 800 determines whether the mean thickness ratio Rave obtained in step S304 is 1.0 or below. If the mean thickness ratio Rave is 1.0 or below (YES in step S305), the processing proceeds to step S306. In step S306, the CPU 800 sets the signal level upper limit Tr to 250, and then the identifying processing of the signal level upper limit Tr ends.

On the other hand, in step S305, if the CPU 800 determines that the mean thickness ratio Rave is greater than 1.0 (NO in step S305), the processing proceeds to step S307. In step S307, the CPU 800 determines whether the mean thickness ratio Rave is 1.2 or below. If the mean thickness ratio Rave is 1.2 or below (YES in step S307), the processing proceeds to step S308. In step S308, the CPU 800 sets the signal level upper limit Tr to 240, and then the identifying processing of the signal level upper limit Tr ends.

On the other hand, in step S307, if the CPU 800 determines that the mean thickness ratio Rave is greater than 1.2 (NO in step S305), the processing proceeds to step S309. In step S309, the CPU 800 determines whether the mean thickness ratio Rave is 1.4 or below. If the mean thickness ratio Rave is 1.4 or below (YES in step S309), the processing proceeds to step S310. In step S310, the CPU 800 sets the signal level upper limit Tr to 230, and then the identifying processing of the signal level upper limit Tr ends.

On the other hand, in step S309, if the CPU 800 determines that the mean thickness ratio Rave is greater than 1.4 (NO in step S309), the processing proceeds to step S311. In step S311, the CPU 800 determines whether the mean thickness ratio Rave is 1.6 or below. If the mean thickness ratio Rave is 1.6 or below (YES in step S311), the processing proceeds to step S312. In step S312, the CPU 800 sets the signal level upper limit Tr to 220, and then the identifying processing of the signal level upper limit Tr ends.

On the other hand, in step S311, if the CPU 800 determines that the mean thickness ratio Rave is greater than 1.6 (NO in step S311), the processing proceeds to step S313. In step S313, the CPU 800 determines whether the mean thickness ratio Rave is 1.8 or below. If the mean thickness ratio Rave is 1.8 or below (YES in step S313), the processing proceeds to step S314. In step S314, the CPU 800 sets the signal level upper limit Tr to 210, and then the identifying processing of the signal level upper limit Tr ends.

If the mean thickness ratio Rave is greater than 1.8, it means that the fine line patch images 602y, 602m, 602c, and 602k are 1.8 times thicker than the solid patch images 601y, 601m, 601c, and 601k.

In step S313, if the mean thickness ratio Rave is greater than 1.8 (NO in step S313), the processing proceeds to step S315. In step S315, the CPU 800 outputs a signal to the display panel 930. According to this signal, the display panel 930 displays a message notifying the user that the thicknesses Ht2y, Ht2m, Ht2c, and Ht2k of the fine line patch images 602y, 602m, 602c, and 602k are too thick.

In step S316, the CPU 800 stops the execution of the image forming operation performed by the image forming units StY, StM, StC, and StK, and then the identifying processing of the signal level upper limit Tr and the image forming processing in FIG. 8 ends. This is because if the signal level upper limit Tr is smaller than 210, the density of the toner image is reduced to an unacceptable level.

FIG. 11 is a flowchart illustrating the identifying processing of the thickness ratio Rk of a black toner image. Processing for detecting the thickness of the fine line patch image 602k and calculating the thickness ratio Rk will be described with reference to FIG. 11. Since the thickness ratios Ry, Rm, and Rc of yellow, magenta, and cyan toner images are identified by a similar method, their descriptions are not repeated.

In step S400, when the identifying processing of the thickness ratio Rk of a black toner image is started, the CPU 800 instructs the laser oscillator 501 to emit light and detects a light-receiving position of the light reflected by the intermediate transfer belt 6 from a current value output from the line sensor 504 according to the above-described method. The current value output from each light-receiving element of the line sensor 504 corresponds to a first signal according to a light-receiving position on the light-receiving face of the line sensor 504 that receives the light reflected by the intermediate transfer belt 6.

In step S401, the CPU 800 resets a time count value t to 0. In step S402, the CPU 800 instructs the image forming unit StK to form the above-described groups of fine line patch images 602k. The CPU 800 forms the fine line patch images 602k by using the image forming condition, which is used for forming the maximum density toner image, stored in the RAM 920. In this processing, the CPU 800 functions as a control unit controlling the formation of the fine line patch image 602k by the image forming unit StK. The image forming condition for forming a maximum density toner image, which has been acquired according to the determining processing of the image forming condition described above with reference to FIG. 8, is stored in the RAM 920 for each color component. According to the present embodiment, the signal level when the thickness of the black solid patch image 601k formed with respect to the image forming condition determined in FIG. 9 is equal to the target thickness, is set to 100 (maximum density). The fine line patch image 602k is formed according to this signal level.

In step S403, the CPU 800 instructs the laser oscillator 501 to emit light and detects the current output from the line sensor 504. The current value of the current output from each light-receiving element of the line sensor 504 is changed according to the light intensity of the received light. Thus, the total of the output current of each light-receiving element corresponds to the amount of reflected light received by the line sensor 504.

In step S404, the CPU 800 determines whether the amount of reflected light detected in step S403 is greater than or equal to a threshold value. The threshold value is a total value of the electric current output from each light-receiving element of the line sensor 504 when the light emitted from the laser oscillator 501 is directed to the exposure region covered with black toner on the intermediate transfer belt 6. Thus, if a total of the current value output from each light-receiving element of the line sensor 504 is greater than or equal to a threshold value, the CPU 800 determines that the light emitted from the laser oscillator 501 is directed to substantially the middle portion of the fine line patch image 602k in the direction perpendicular to the conveying direction of the intermediate transfer belt 6.

In step S404, if the CPU 800 determines that the total of the output current of each light-receiving element of the line sensor 504 is greater than or equal to a threshold value (YES in step S404), the processing proceeds to step S405. In step S405, according to the above-described method, the CPU 800 detects the light-receiving position of the light reflected by the fine line patch image 602k of the black image. The value of the current output from each light-receiving element of the line sensor 504 corresponds to a second signal. The second signal is a signal that corresponds to a light-receiving position on the light-receiving face of the line sensor 504 that receives the light reflected by the fine line patch image 602k. Further, the line sensor 504 functions as an output unit outputting a signal corresponding to the thickness of a fine line patch image.

In step S406, according to the above-described method, the CPU 800 detects the thickness Ht2k of the patch image 602k from the light-receiving position of the light reflected by the intermediate transfer belt 6 and detected in step S400 and the light-receiving position of the fine line patch image 602k detected in step S405. In this processing, the CPU 800 functions as an output unit outputting a signal corresponding to the patch image thicknesses Ht2k, Ht2c, Ht2m, and Ht2y of the fine line patch images.

In step S407, the CPU 800 determines whether the time count value t is greater than or equal to a predetermined time value. The predetermined time value is the time that elapsed from the start of the formation of the group of the fine line patch images 602k to the time all the fine line patch images 602k have passed the exposure region.

On the other hand, in step S404, if the CPU 800 determines that the amount of reflected light is smaller than a threshold value (NO in step S404), the CPU 800 does not detect the light-receiving position of the light reflected by the fine line patch image 602k, and the processing proceeds to step S407. More specifically, in step S404, if the amount of reflected light is smaller than the threshold value, in other words if a total of the current output from each light-receiving element of the line sensor 504 is smaller than the threshold value, the CPU 800 determines that the fine line patch image 602k has not yet reached the exposure region.

In step S407, if the time count value t is smaller than a predetermined value (NO in step S407), the CPU 800 determines that not all of the fine line patch images 602k has passed the exposure region, and the processing proceeds to step S408. In step S408, the CPU 800 increments the time count value t by 1, and the processing returns to step S403. By repeating the processing in steps S403 to S408, the CPU 800 continues to detect the value of the current output from the line sensor 504 until one of the fine line patch images 602k reaches the exposure region.

On the other hand, in step S407, if the time count value t is greater than or equal to a predetermined value (YES in step S407), the processing proceeds to step S409. In step S409, the CPU 800 determines the maximum value of the thickness Ht2k of the patch image 602k detected in step S406 as the thickness Ht2k of the fine line patch image 602k.

In step S410, the CPU 800 calculates the thickness ratio Rk using the thickness Ht1k of the black solid patch image 601k and the thickness Ht2k of the fine line patch image 602k determined in step S409, and then the identifying processing of the thickness ratio Rk of the black toner image ends. The thickness Ht1k of the black solid patch image 601k used in step S410 can be acquired from the thickness Ht1k of the black solid patch image 601k detected in the determining processing of the above-described image forming condition (see FIG. 10).

Since yellow, magenta, cyan, and black have different spectral characteristics, the threshold value used in step S404 described above varies with the color component. Thus, the threshold value is measured in advance for each color component and stored in the ROM 910.

Next, the signal level correction processing executed in step S104 of the image forming processing in FIG. 8 will be described. The CPU 800 according to the present embodiment converts the image data into bitmap data and sums up the signal level of each color component for each pixel of a character image, a line image, and a photographic image. Then the signal level of each color component for each pixel is corrected such that the obtained total value is smaller than or equal to the signal level upper limit Tr which is identified by the identifying processing of the signal level upper limit Tr (see FIG. 10).

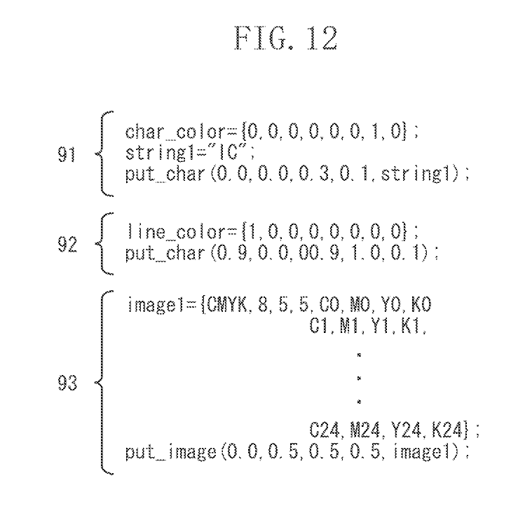

FIG. 12 illustrates an example of image data written in page description language and sent from an external apparatus (PC) to the image forming apparatus. The image data written in page description language is broadly divided into (a) text data, (b) graphics data, and (c) raster image data.

Text data 91 of the image data is a command of text data which is converted into characters when the conversion of the image data into bitmap data is performed. The text data 91 designates a character type, a character color, a signal level (density) of the character color, a position on the sheet P, a character size, and a character interval.

Graphics data 92 of the image data is a command of graphics data which is converted into a line image when the conversion of the image data into bitmap data is performed. The graphics data 92 designates a line color, a signal level (density) of the line color, coordinates of the starting point and the endpoint of the line, and a thickness of the line.

Raster image data 93 of the image data is a command of raster image data which is converted into a photographic image when the conversion of the image data into bitmap data is performed. The raster image data 93 designates a number of the color components of the photographic image, a signal level (density) of each dot, and a layout position of the photographic image.

As described above, image data written in a page description language can be identified whether it is data of a character, a line image, or a photographic image according to the command.

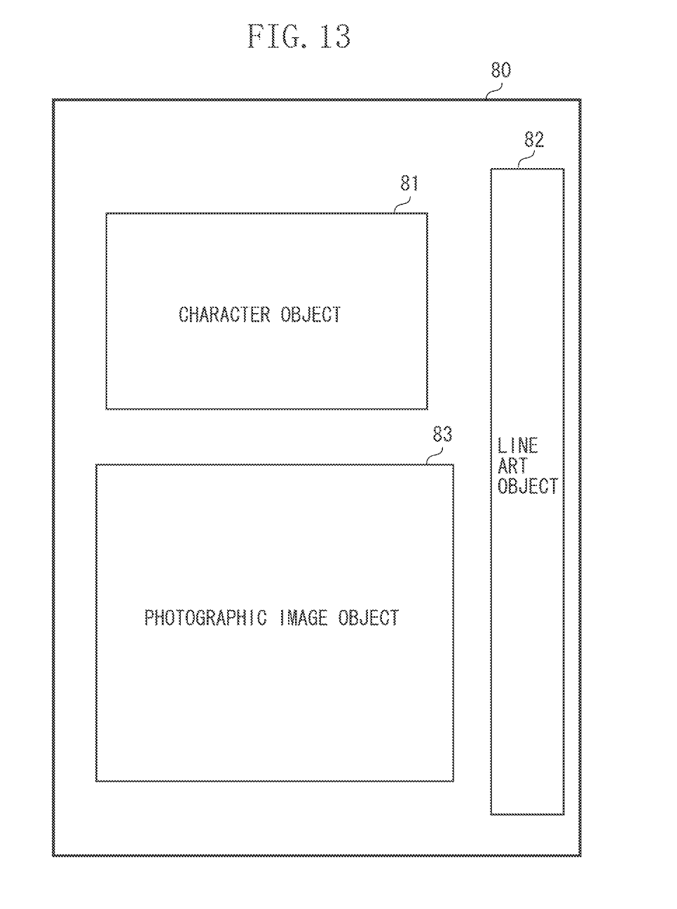

FIG. 13 is a schematic diagram illustrating the image data in FIG. 12 converted into bitmap data. In FIG. 13, a character object area 81, a line image object area 82, and a photographic image object area 83 are arranged in an area 80 of one sheet. The character object area 81 is where an image obtained from the text data 91 (FIG. 12) is formed. The line image object area 82 is where an image obtained from the graphics data 92 (FIG. 12) is formed. The photographic image object area 83 is where an image obtained from the raster image data 93 (FIG. 12) is formed.

According to the present embodiment, if image data is input, the CPU 800 sequentially converts each command of the image data into bitmap data and, at the same time, corrects the signal level for each object (character object, line image object, or photographic image object). Next, the signal level correction processing in step S104 in FIG. 8 will be described with reference to the flowchart in FIG. 14. The processing of this flowchart is realized by the CPU 800 reading out and executing a program stored in the ROM 910.

In step S500, the CPU 800 reads the image data and determines whether a line image object is obtained according to the conversion of the image data. If a command of the image data which is being converted is graphics data, the CPU 800 determines that a line image object is obtained when the command is executed. If a line image object is obtained as a result of the conversion of the image data (YES in step S500), the processing proceeds to step S502.

On the other hand, if a line image object is not obtained as a result of the conversion of the image data (NO in step S500), the processing proceeds to step S501. In step S501, the CPU 800 determines whether a character object is obtained according to the conversion of the image data. If the command of the image data which is being converted is text data, the CPU 800 determines that a character object is obtained when the command is executed. If a character object is not obtained as a result of the conversion of the image data (NO in step S501), the CPU 800 determines that the result obtained from the conversion of the image data is a photographic image object, and the processing proceeds to step S506.

On the other hand, in step S501, if a character object is obtained as a result of the conversion of the image data (YES in step S501), the processing proceeds to step S502. In step S502, the CPU 800 determines whether the character object includes a fine line. At this time, the CPU 800 identifies a character which is smaller than or equal to a predetermined character size designated by the command of the image data. According to the present embodiment, the predetermined character size is set to 14 point.

Further, if the CPU 800 determines that a line image is obtained as a result of the conversion of the image data in step S500 described above, in step S502, the CPU 800 determines whether the line image includes a fine line area. In other words, the CPU 800 identifies a line image whose line width determined by the command of the image data is smaller than or equal to a predetermined width. According to the present embodiment, the predetermined line width is set to 500 μm.

In step S502, if the character object or the line image object includes a fine line area (YES in step S502), the processing proceeds to step S503. In step S503, the CPU 800 determines whether the total of the signal levels is greater than 250.

In step S503, if the image data is text data, the CPU 800 determines whether a total of the signal levels of each color component is greater than 250 according to the designated character color and its signal level (density). Further, in step S503, if the image data is graphics data, the CPU 800 determines whether a total of the signal levels of each color component is greater than 250 according to the designated line color and its signal level (density). In step S503, if the total of the signal levels is greater than 250 (YES in step S503), the processing proceeds to step S504. In step S504, the CPU 800 corrects the signal level of each color component according to the equations 1 to 4 described above, and then the processing proceeds to step S509.

In step S504, the signal level upper limit Tr used in the equations 1 to 4 described above employs the signal level upper limit Tr which has been identified according to the identifying processing of the signal level upper limit Tr (see FIG. 10) described above. In step S504, the CPU 800 functions as an second determining unit that determines a second image forming condition used for forming a toner image with a width smaller than or equal to a predetermined width by correcting the signal level of a same pixel position based on the signal level upper limit Tr which has been identified according to the mean thickness ratio Rave.

On the other hand, in step S503, if the total signal level is 250 or lower (NO in step S503), the processing proceeds to step S505. In step S505, the CPU 800 corrects the signal level of each color component according to equations 10 to 13 below, and the processing proceeds to step S509. In step S505, regarding a toner image whose total of the signal levels of each color component is 250 or lower, the signal level of each color component is corrected such that the toner image is not formed with a density higher than a toner image whose signal level is corrected due to high signal level (signal level higher than 250).

According to the equations 10 to 13, the ratio of the signal level upper limit Tr identified in step S101 described above to the upper limit of the signal level (250 according to the present embodiment) when the thicknesses Ht2k, Ht2c, Ht2m, and Ht2y of the fine line toner images are the same as the thicknesses Ht1k, Ht1c, Ht1m, and Ht1y of the solid toner images of the corresponding color is multiplied by the signal level of each color component.

$$\begin{matrix}Y 1 = \frac{Tr}{250} * Y 0 , ( Y 0 + M 0 + C 0 + K 0 < 250 ) & ( equation 10 ) \\ M 1 = \frac{Tr}{250} * M 0 , ( Y 0 + M 0 + C 0 + K 0 < 250 ) & ( equation 11 ) \\ C 1 = \frac{Tr}{250} * C 0 , ( Y 0 + M 0 + C 0 + K 0 < 250 ) & ( equation 12 ) \\ K 1 = \frac{Tr}{250} * K 0 , ( Y 0 + M 0 + C 0 + K 0 < 250 ) & ( equation 13 )\end{matrix}$$

The signal level upper limit Tr stored in the RAM 920 according to the identifying processing of the signal level upper limit Tr (see FIG. 10) will be used for the signal level upper limit Tr in the equations 10 to 13.

In the equations 10 to 13, Y0 is a signal level used for forming a yellow toner image before the correction, M0 is a signal level used for forming a magenta toner image before the correction, C0 is a signal level used for forming a cyan toner image before the correction, and K0 is a signal level used for forming a black toner image before the correction.

Further, in the equations 10 to 13, Y1 is a signal level used for forming a yellow toner image after the correction, M1 is a signal level used for forming a magenta toner image after the correction, C1 is a signal level used for forming a cyan toner image after the correction, and K1 is a signal level used for forming a black toner image after the correction.

In step S506, the CPU 800 determines whether the total of the signal levels of each color component is greater than 250 according to the signal level (density) of each dot designated by the image data.

Further, in step S502, if the character object or the line image objected obtained by the conversion does not include a fine line area (NO in step S502), the processing proceeds to step S506. In step S506, the CPU 800 determines whether the total signal level is greater than 250.

In step S506, if the image data is text data, the CPU 800 determines whether the total of the signal levels of each color component is greater than 250 according to the color of the designated character and its signal level (density). Further, in step S506, if the image data is graphics data, the CPU 800 determines whether the total of the signal level of each color component is greater than 250 according to the color of the designated line and its signal level (density). In step S506, if the total of the signal levels is greater than 250 (YES in step S506), the processing proceeds to step S507. In step S507, the CPU 800 corrects the signal level of each color component according to the above-described equations 1 to 4 where the signal level upper limit Tr is set to 250, and then the processing proceeds to step S509.

On the other hand, in step S506, if the total of the signal levels is 250 or lower (NO in step S506), the processing proceeds to step S508. In step S508, the CPU 800 does not perform the correction processing of the signal level, and the processing proceeds to step S509.

In step S509, the CPU 800 determines whether all the signal levels of the commands written in the image data have been converted. In step S509, if all the signal levels have been converted (YES in step S509), the signal level correction processing ends. Then, the processing returns to step S105 of the image forming processing (see FIG. 8) described above.

On the other hand, in step S509, if all the signal levels have not been converted yet (NO in step S509), the processing returns to step S500, and the signal level correction processing is continued until the signal levels of all the commands are converted.

In this manner, according to the present embodiment, when an image corresponding to the input image data is formed, a character which is smaller than or equal to a predetermined size and a line image whose line width is smaller than or equal to a predetermined width can be formed by an amount of toner that does not cause the toner scattering.

According to the present embodiment, the CPU 800 detects the thickness Ht1y, Ht1m, Ht1c, and Ht1k of the solid patch images 601y, 601m, 601c, and 601k instead of detecting the density of the solid patch images 601y, 601m, 601c, and 601k. In other words, the thickness detection unit 5 functions as a density detection unit that detects the density of the solid patch images. However, the density detection unit that detects the density of the solid patch images 601y, 601m, 601c, and 601k is not limited to the thickness detection unit 5. For example, a publicly known density sensor that includes a light emitting unit that emits light to the intermediate transfer belt 6 and a light-receiving unit that receives the light reflected by a solid patch image and detects the density from the amount of reflected light can also be used.

Further, according to the present embodiment, instead of determining the image forming condition based on a density of a solid patch image, the CPU 800 determines the image forming condition based on the condition where the thicknesses of the solid patch images Ht1y, Ht1m, Ht1c, and Ht1k are set to a target thickness of the solid patch image formed with the maximum density. However, the image forming condition can also be determined based on a measurement result of a density sensor that detects the density of the above-described amount of reflected light. Further, a service person or a user can change the image forming condition by examining the density of the toner image fixed on the sheet.

Next, a second exemplary embodiment will be described. The present embodiment differs from the first exemplary embodiment in the following points. Since the components of the present embodiment are similar to those used in the first exemplary embodiment, their descriptions are not repeated.

According to the first exemplary embodiment, the pattern of the fine line patch images 602 is shifted to the direction perpendicular to the conveying direction of the intermediate transfer belt 6 with respect to the preceding pattern of the fine line patch images 602. According to the present embodiment, the fine line patch image 602 is formed at a predetermined angle with respect to the conveying direction of the intermediate transfer belt 6.

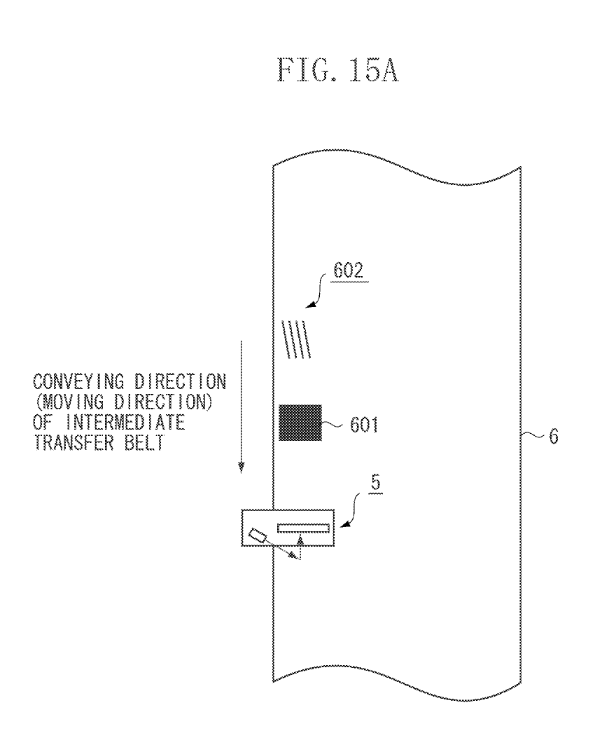

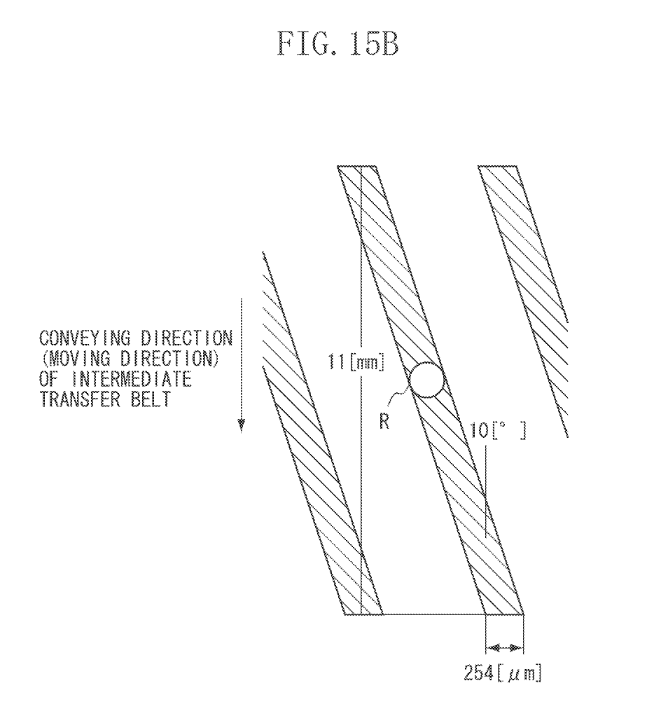

FIG. 15A is an overall view of the solid patch image 601 and the fine line patch image 602 formed on the intermediate transfer belt 6. FIG. 15B is an enlarged view of the fine line patch image 602.

According to the present embodiment, one fine line patch image 602 with a width of 254 μm in the direction perpendicular to the conveying direction of the intermediate transfer belt is formed on the intermediate transfer belt at an angle of 10 degrees with respect to the conveying direction. Further, the length of the line patch image 602 in the conveying direction of the intermediate transfer belt 6 is 11 mm.

Four pieces of this fine line patch image 602 are arranged side by side in the direction perpendicular to the conveying direction of the intermediate transfer belt 6. In this manner, at least one of the fine line patch images 602 can reliably pass the exposure region R on the intermediate transfer belt 6 exposed to the light emitted from the laser oscillator 501. Accordingly, the thickness of the fine line patch image 602 can be detected. The width of the area of the plurality of the fine line patch images 602 carried on the intermediate transfer belt 6 is greater than or equal to a distance the intermediate transfer belt 6 moves in the direction perpendicular to the conveying direction.

According to the first and the second exemplary embodiments, the fine line patch image 602 is formed on the intermediate transfer belt 6 and its thickness is detected. However, instead of detecting the fine line patch image formed on the intermediate transfer belt, the thickness of the fine line patch image 602 carried on each of the photosensitive drums 1Y, 1M, 1C, and 1K of the image forming units StY, StM, StC, and StK can be detected. Further, the thickness of the fine line patch image 602 transferred to the sheet can also be detected. If the photosensitive drums 1Y, 1M, 1C, and 1K are used as the image carrier, one thickness detection unit 5 will be provided for each photosensitive drum for the detection of the thickness of the fine line patch image 602 on the image carrier.

Further, according to the first and the second exemplary embodiments, the image forming condition used for forming a fine line area is determined by forming a fine line patch image of a predetermined width on the intermediate transfer belt 6 and detecting the thickness of the patch image. However, the image forming condition can be determined by forming on the intermediate transfer belt 6 a plurality of fine line patch images having different widths in the direction perpendicular to the conveying direction of the intermediate transfer belt 6, and detecting the thicknesses of the patch images. Then, image forming conditions corresponding to the width of the toner image can be determined.

According to the first and the second exemplary embodiments, regardless of the longitudinal direction of a character or a fine line included in an image, toner scattering that occurs at a character or a fine line portion can be prevented.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-046515 filed Mar. 3, 2011, which is hereby incorporated by reference herein in its entirety.

What is claimed is:

1. An image forming apparatus comprising:
an image carrier configured to carry an image;
a conveyance unit configured to convey the image carrier;
an image forming unit configured to form an image on the image carrier according to image data;
a first determining unit configured to determine a first image forming condition of the image forming unit for forming a heavy line image at a width that is wider than a predetermined width such that a thickness of the heavy line image, in a direction orthogonal to a surface of the image carrier, is thinner than or equal to a predetermined thickness;
a control unit configured to cause the image forming unit to form a first measurement image having a width that is narrower than or equal to the predetermined width such that a length of the first measurement image, in a direction perpendicular to a conveying direction of the image carrier by the conveyance unit, is shorter than a predetermined length;
an irradiation unit configured to emit light onto the image carrier;
an output unit configured to output a first signal corresponding to a thickness of the first measurement image in a direction orthogonal to the surface of the image carrier by receiving light reflected by the first measurement image; and
a second determining unit configured to determine a second image forming condition of the image forming unit for forming a fine line image at a width that is narrower than or equal to the predetermined width, based on the first signal output by the output unit, such that the thickness of the fine line image is thinner than or equal to the predetermined thickness.

2. The image forming apparatus according to claim 1, wherein the control unit causes the image forming unit to form a plurality of the first measurement images while shifting positions in the direction perpendicular to the conveying direction, and
wherein a longitudinal direction of each of the first measurement images is parallel to the conveying direction.

3. The image forming apparatus according to claim 2, wherein the control unit causes the image forming unit to form a plurality of the first measurement images while shifting positions by one pixel in the direction perpendicular to the conveying direction.

4. The image forming apparatus according to claim 1, wherein the control unit causes the image forming unit to form the first measurement image at a predetermined angle with respect to the conveying direction.

5. The image forming apparatus according to claim 2, wherein, in the direction perpendicular to the conveying direction, a distance from one end to the other of the plurality of the first measurement images is longer than a distance in the direction perpendicular to the conveying direction that the image carrier moves as a result of meandering while the conveying unit conveys the image carrier.

6. The image forming apparatus according to claim 4, wherein, in the direction perpendicular to the conveying direction, a length of the first measurement image on the image carrier is longer than a distance in the direction perpendicular to the conveying direction that the image carrier moves as a result of meandering while the conveying unit conveys the image carrier.

7. The image forming apparatus according to claim 1, wherein the second determining unit determines an image forming condition corresponding to a width of the image formed by the image forming unit according to image data by adjusting the first image forming condition determined by the first determining unit according to the first signal output by the output unit.

8. The image forming apparatus according to claim 1, wherein the control unit causes the image forming unit to form a second measurement image having a width that is wider than the predetermined width, and
wherein the first determining unit determines the first image forming condition based on a result of a detection of a density of the second measurement image.

9. The image forming apparatus according to claim 8, wherein the first measurement image is formed with an image forming condition in which the second measurement image has been formed by the image forming unit.

10. The image forming apparatus according to claim 1, wherein the control unit causes the image forming unit to form a second measurement image having a width that is wider than the predetermined width,
the output unit outputs a second signal corresponding to a thickness of the second measurement image by receiving light reflected by the second measurement image, and
the first determining unit determines the first image forming condition based on the second signal output by the output unit.

11. The image forming apparatus according to claim 1, wherein the first measurement image is formed with the first image forming condition determined by the first determining unit.

12. The image forming apparatus according to claim 1, wherein a diameter of a light emitted onto the first measurement image by the irradiation unit is smaller than a width of the first measurement image.
